(19) United States
(12) Patent Application Publication
(10) Pub. No.: US 2026/0192540 A1
(43) Pub. Date: Jul. 9, 2026

(54) APPAREL ARTICLE WITH COMPOSITE TEXTILE HAVING WATER-RESISTANT PROPERTIES AND A SURFACE TEXTURE

(71) Applicant: NIKE, Inc., Beaverton, OR (US)

(72) Inventors: Yang-Hua Ou, Beaverton, OR (US); Christopher J. Ranalli, Portland, OR (US); Lai-Hung Wan, Taoyuan (TW)

(21) Appl. No.: 19/442,791

(22) Filed: Jan. 7, 2026

Related U.S. Application Data
(60) Provisional application No. 63/743,230, filed on Jan. 8, 2025.

(51) Int. Cl. B32B 5/02; B32B 3/28; B32B 27/12; B32B 27/40

(52) U.S. Cl. CPC B32B 5/022; B32B 3/28; B32B 27/12; B32B 27/40; B32B 2250/02; B32B 2255/10; B32B 2255/26; B32B 2262/0276; B32B 2262/0284; B32B 2307/538; B32B 2307/724; B32B 2307/7265; B32B 2437/00

(57) ABSTRACT

A composite textile can include various layers, such as a nonwoven layer and a waterproof, breathable membrane. The composite textile can include various properties, such as waterproofness, water repellency, and the like. In addition, the composite textile can be manufactured using various techniques, which can be configured to impart desired properties. The composite textile can be suitable to form articles designed for inclement weather. In some examples, the composite textile can include a surface texture or surface topographical feature (e.g., wrinkle-like surface ornamentation).

### CROSS REFERENCE TO RELATED APPLICATIONS

This application claims the priority benefit of U.S. patent application Ser. No. 63/743,230 (filed January 8, 2025), which is hereby incorporated herein by reference in its entirety.

### TECHNICAL FIELD

This specification describes composite textiles that are for wearable articles and that include water-resistant and/or water-proof properties and include a desired surface texture.

### BACKGROUND

Conventional articles (e.g., wearable articles, bags, etc.) designed for inclement weather conditions (e.g., precipitation) generally are formed from a knit or woven textile. In some cases, the knit or woven textile can be combined with a waterproof, breathable membrane. Knit and/or woven textiles are often manufactured using processes (e.g., knitting, weaving, dyeing, etc.) that are less sustainable and/or that consume relatively high amounts of energy. In addition, a surface ornamentation can be limited in some instances.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The at least one drawing in color can also include greyscale versions of the at least one drawing, and greyscale versions are submitted together with this specification in an Appendix, which is incorporated by reference herein in its entirety.

Subject matter of this disclosure is related to composite textiles that are for wearable articles and that include water-resistant and/or water-proof properties and include a desired surface texture. The subject matter is described in detail below with reference to these figures.

FIG. 1 illustrates wearable articles with a waterproof, breathable composite textile in at least some examples.

FIG. 2 illustrates operations related to constructing a waterproof, breathable composite textile based on some examples.

FIGS. 3-7 provide images of various composite textiles based on some examples.

FIG. 8 depicts an example of a sample of a composite textile for surface-texture property analysis.

FIG. 9 depicts an example of a sample of a composite textile for surface-texture property analysis.

FIG. 10 includes a black and white optical 3D model rendering of a composite textile.

FIG. 11 includes a color-coded plan rendering of the composite textile represented in FIG. 10 in which each color represents a respective z-height based on a scale.

FIG. 12 includes a color-coded perspective rendering of the composite textile represented in FIG. 10 and FIG. 11 showing z-height dimensionality, also using a color-coding scale.

FIG. 13 includes the rendering in FIG. 10 with profile line markings and with profile-line data for each of the profile lines.

FIG. 14 includes the rendering in FIG. 11 with area designations and with surface-texture data for each of the designated areas.

### DETAILED DESCRIPTION

This specification describes a composite textile that includes waterproof and/or water-resistant properties, that is breathable, and that includes aesthetic elements suitable for use in a wide variety of apparel articles, which can include reuseable inclement weather apparel (e.g., jackets, pants, and footwear worn during inclement weather, such as precipitation). In examples of this disclosure, the composite textile can include one or more nonwoven layers (e.g., a spunlace layer, staple-fibers web, and/or other type(s) of nonwoven textile(s) such as spunbond, meltblown, and the like) combined with a waterproof, breathable membrane (e.g., a polymer film, such as a polyurethane film). The composite can include various other elements as well, such as a DWR coating, antipilling coating, colorants, waterproof coatings, and anti-cling coatings. In at least some examples, the composite textile can include a surface texture or surface topographical feature (e.g., wrinkles) on one or more faces, which can contribute to one or more of a hand-feel, drape, and an aesthetic of the apparel. In examples, dimensions associated with the surface topographical features are controlled to reduce the likelihood that debris (e.g., dirt, dust, VOCs, stains, etc.) might be trapped in the feature, which would reduce the usability of the composite textile for wearable articles. Other elements of the composite textile can also contribute to reducing the likelihood of trapping debris, such as a DWR coating, antipilling treatment, and the like.

In contrast to some conventional waterproof textiles, the subject matter of the present disclosure can be more sustainable, such as by using fewer resources to manufacture, by being conducive to manufacturing with recycled materials (e.g., shredded articles), by being easier to recycle into future products, and the like. In addition, examples of the composite textile can include a desired surface-texture aesthetic (e.g., surface wrinkles) on a face of the textile, which can be used to form the outermost face of wearable articles. In at least some examples, the desired surface-texture aesthetic can be imparted to the composite textile without additional post processing steps or with fewer post processing steps, which can also contribute to the sustainability of the composite textile, by using less resources and materials to construct an aesthetically pleasing textile that can be used to construct wearable articles.

In contrast to the present disclosure, some conventional textiles designed for inclement conditions (e.g., precipitation) generally are formed from a knit or woven textile combined with a durable water repellant (DWR) coating and/or a waterproof, breathable membrane (e.g., may be layered with or sandwiched or positioned between knit and/or woven textiles). Knit and/or woven textiles are often manufactured using processes (e.g., knitting or weaving) that can be less sustainable and/or that consume more energy than other textile manufacturing processes. Moreover, coloring processes used to finish knit and/or woven textiles generally consume a high amount of energy. For example, a typical dyeing process for knit and/or woven textiles includes a water dyeing process along with a drying process. Both the water consumption and the energy used to dry the textile increase the carbon footprint of the textile. Furthermore, the structure of conventional knit and/or woven textiles is typically not conducive to incorporating fibers derived from varied categories of recyclable and/or recycled goods, including shredded articles, which may limit sustainability. Furthermore, conventional textiles often implement additive techniques (e.g., printing) to add aesthetic elements or other visual embellishments to the face of the textile, which can increase manufacturing costs and can require additional materials and manufacturing resources. In yet some other examples of conventional textiles, nonwoven textiles (e.g., composites with nonwoven textiles) can have an aesthetic appearance (e.g., on an outermost face) that is less desirable for some wearable articles, such as reusable inclement weather apparel (e.g., jackets).

As indicated, examples of this disclosure can include a composite textile incorporating one or more nonwoven textile layers and sustainable processes for forming the same, where the composite textile is suitable to form articles designed for inclement weather such as rain, sleet, snow, or other precipitation. Some nonwoven textiles by themselves can be porous due to the spaces between entangled fibers. In some instances, these spaces can permit water to pass through the textile and/or can sometimes trap water and/or moisture and, as such, some nonwoven textiles have traditionally not been used for articles designed for inclement weather. Examples of this disclosure contemplate combining one or more nonwoven textile layers with a waterproof, breathable membrane (e.g., a polymer film, such as a polyurethane film) and/or a durable water repellant deposit to impart waterproof and/or water repellant properties to the composite textile.

In general, the composite textile disclosed herein, in contrast to conventional nonwoven textiles (e.g., textiles comprising a knit, braided, and/or woven construction), is sustainable and/or is sustainably produced. For example, the nonwoven textile layers may incorporate fibers from disparate recycled-fiber sources, which provides additional utilization options for various end-of-life articles. In contrast to the present disclosure, conventional textiles and systems may limit the sources from which recycled fibers are accepted and fail to provide non-landfill disposal options for various types of goods. Moreover, the composite textile described herein may be part of a closed loop or a semi-closed loop that uses a raw material (e.g., a polymer material) to produce an article of apparel and that repeatedly uses that same raw material (e.g., the same polymer material) to produce subsequent generations of articles of apparel. Among other things, these aspects contribute to sustainability by using and reusing materials that may otherwise be discarded in a landfill.

In line with this, aspects herein contemplate that the composite textile, and articles of apparel formed from the composite textile, are fully recyclable. Stated differently, the nonwoven textile layer(s) and the waterproof, breathable membrane in the composite textile may be from the same or similar polymer class which facilitates complete recyclability as well as ease of recyclability (e.g., components of the composite textile do not have to separated or sorted prior to recycling or shredding) of the textile and/or apparel. For example, fibers (i.e., fibers or filaments) selected to form the nonwoven textile layers may include recycled materials including recycled polyethylene terephthalate (PET) fibers, commonly known as polyester fibers. Additionally, materials selected to form the waterproof, breathable membrane may include recycled materials that may be from the same or similar polymer class as the fibers in the nonwoven textile layers. Because the fibers and the materials used to form the waterproof, breathable membrane are from the same or similar polymer class, the components of the composite textile generally do not have to be separated prior to recycling. Further, use of recycled fibers and materials reduces the carbon footprint of the composite textile.

In at least one example, a composite textile can include a nonwoven textile layer bonded to a waterproof, breathable membrane. The nonwoven textile layer can include one or more various treatments, such as a durable water repellant (DWR) deposit, anti-pilling coating, and the like. When the first composite textile is formed into an article (e.g., wearable article, bag, etc.), the nonwoven textile layer can form an outer-facing surface of the article. Thus, the outer-facing surface of the article generally repels water due at least in part to the durable water repellant deposit. In addition, the use of the waterproof, breathable membrane creates an additional barrier to water penetration while still allowing vapor (e.g., moisture vapor produced by the wearer) to escape to the external environment, which contributes to wearer comfort.

Nonwoven textiles can, in some cases, be prone to pilling. Examples of this disclosure can include applying a chemical binder to the nonwoven textile layer to create a plurality of chemical bonding sites. As a result, one or more fibers of the nonwoven textile layer can be adhered together at the chemical bonding sites, which can reduce the tendency of the terminal ends of the fibers from migrating and entangling to form pills. In example aspects, the chemical binder is applied only to the nonwoven textile layer forming the outer-facing surface of the wearable article, as this layer may be more prone to pilling due to abrasion with objects in the external environment compared to the second nonwoven textile layer.

Examples also can contemplate that the nonwoven textile layer (e.g., the fibers of the nonwoven textile layer) may include a colorant, such that the resulting composite textile has a pleasing color and/or pattern aesthetic. In at least some examples, the colorant can be embedded added at the fiber level and/or at the textile layer and/or at the composite level. In some examples, the colorant can be added or applied to the nonwoven via CO₂ as a medium, instead of water. For instance, CO₂ can be transitioned to a supercritical state (SC-CO₂), in which the CO2 can have a very high solvent power, allowing the colorant (e.g., dye or pigment) to dissolve easily. Due to high permeability, dyes can be transported easily and deeply into fibers (e.g., fiber impregnation or infusion), which can contribute to vibrant colors. In some cases, these processes can use less energy than other dyeing processes (e.g., often associated with knit and/or woven textiles) and may lower the overall carbon footprint of the composite textile. In some examples, the nonwoven textile layer is dope dyed. In some examples, the nonwoven textile is piece dyed.

The order in which the durable water repellant, the chemical binder, and the printed component are applied to the first nonwoven textile layer can, in some cases, be selected to improve the performance, operation, and functionality of each of the deposits. For example, the printed component, whether applied by way of a colorant or a sublimation printing process or CO₂ process, may be applied prior to bonding the first nonwoven textile layer to the waterproof, breathable membrane. In example aspects, this can be done because the typically higher temperatures associated with applying color or dye (e.g., from about 140 degrees Celsius to about 160 degrees Celsius) may impact the structural integrity of the waterproof, breathable membrane which may have a melting point of, for example, around 150-160 degrees Celsius. In some examples, these processes can be carried out in any order, and/or the steps can be rearranged.

As used herein, the term “article of apparel” is intended to encompass articles worn by a wearer, which can also be referred to as apparel articles or “wearable articles.” Wearable articles can include upper-body garments (e.g., tops, t-shirts, pullovers, hoodies, jackets, rain jackets, all-weather jackets, coats, and the like); lower-body garments (e.g., pants, shorts, tights, capris, unitards, and the like); headwear; gloves and mittens; sleeves (arm sleeves, calf sleeves); footwear articles (e.g., uppers for shoes); and the like. Aspects herein contemplate embodiments where the composite textile, and/or the wearable article, and/or the article of apparel does not comprise any knit, braided, and/or woven construction. In some examples, the composite textile of the present disclosure can be combined (e.g., to form an apparel article) in a layered construction with one or more other textile layers (e.g., insulation layer, wind-barrier layer, etc.).

As used herein, the term “finished goods” may include articles of apparel or wearable articles, equipment such as bags, furniture, and other such items.

As used herein, the term “roll goods” may include, for example, rolls of textile, scraps or remnants remaining after pieces are cut from rolls, and the like.

The term “inner-facing surface” when referring to the wearable article means the surface that is configured to face towards a body surface of a wearer (or away from an external environment), and the term “outer-facing surface” means the surface that is configured to face opposite of the inner-facing surface, away from the body surface of the wearer, and toward an external environment. The term “innermost-facing surface” or “innermost surface” means the surface closest to the body surface of the wearer with respect to other layers of the wearable article, and the term “outermost-facing surface” or “outermost surface” means the surface that is positioned furthest away from the body surface of the wearer with respect to the other layers of the wearable article.

As used herein, the term “nonwoven” or “nonwoven layer” or “nonwoven textile” or “nonwoven textile layer” refers to fibers and/or filaments that are held together by mechanical and/or chemical interactions without being in the form of a knit, woven, braided construction, or other structured construction. The terms “fibers” and “filaments” both generally refer to a material having a high ratio of length to cross-sectional area. Fibers (including “staple fibers”) can differ from filaments in that fibers are typically shorter, based on their natural state (e.g., wool, cotton, etc.), based on the manner in which they are manufactured (e.g., cut to a desired staple length), and/or based on fiber source (e.g., shredded-article fibers which may have differing or varied lengths). On the other hand, filaments can often be longer than fibers and often have an undefined length that is generated based on the method of manufacture. However, in some instances, filaments can have shorter lengths than fibers. Aspects herein contemplate that fibers and/or filaments may be used to form the nonwoven layers. When referring to fibers the same description can also refer to or describe filaments and vice versa, unless expressly indicated otherwise.

In some examples, a nonwoven layer includes a collection of fibers (i.e., fibers and/or filaments) that are mechanically manipulated to form a mat-like material. Stated differently nonwoven textiles are directly made from fibers and/or filaments. The nonwoven textile may include different webs of fibers formed into a cohesive structure, where the different webs of fibers may have a different or similar composition of fibers and/or different properties. Examples of nonwoven textiles can include a fiber web formed with staple or shredded fibers (e.g., a carded web of staple fibers that can, in some instances, be cross lapped and/or pre-needled), a spunbond textile, a spunlace textile, a melt-blown textile, an electrospun textile, and the like, and any and all combinations thereof.

In example aspects, the mechanical manipulation contemplated herein may include needle entanglement (i.e., needlepunching) and/or fluid entanglement (i.e., hydroentanglement). Needlepunching generally uses barbed or spiked needles to reposition a percentage of fibers or filaments from a generally horizontal orientation (an orientation extending along an x, y plane) to a generally vertical orientation (a z-direction orientation). Hydroentanglement generally uses fine, high pressure jets of water which penetrate a web of fibers and/or filaments, which may be carded and/or cross-lapped, causing the fibers and/or filaments to entangle. One example nonwoven textile created using hydroentanglement is commonly known as spunlace. Spunlace nonwoven textiles are generally commercially available, inexpensive, and lightweight.

The fibers (i.e., fibers and/or filaments) contemplated herein may be formed of a number of different materials (e.g., cotton, nylon and the like) including polyester, such as polyethylene terephthalate (PET). The fibers may include virgin material fibers (fibers that have not been recycled) and/or recycled material fibers. Recycled fibers include “shredded-article fibers” and/or “re-pelletized polymer fibers.” As used herein, shredded-article fibers include fibers that are direct by-products of shredding a fiber-containing article (e.g., knit, woven, nonwoven, etc.). In some examples, shredded-article fibers may be derived without pelletizing and extrusion through processes that consume less energy, and as such, textiles that incorporate shredded-article fibers may have a lower carbon footprint. In general, due to the shredding process, shredded-article fibers generally have a varied length with respect to each other. In addition, shredded-article fibers can include clumps of textile resulting from the shredding process that are small enough to be carded and formed into a fiber web. Re-pelletized polymer fibers include fibers that are extruded from pelletized or chipped by-products derived from polymer-containing sources (e.g., polymer-containing bottles or containers; polymer-fiber articles that are knit, woven, nonwoven; roll goods; textile manufacturing scrap; fiber webs at various stages of carding, lapping, pre-needling, and needling; etc.). In general, re-pelletized polymer fibers generally have a uniform length.

When referring to the composite textile described herein, the composite textile may include a first face and an opposite second face which both face outward with respect to an interior of the composite textile and comprise the outermost faces of the composite textile. As such, when viewing the composite textile, the first face and the second face are each fully visible. The first face and the second face may both extend along x, y planes that are generally parallel and offset from each other. For instance, the first face may be oriented in a first x, y plane and the second face may be oriented in a second x, y plane generally parallel to and offset from the first x, y plane.

The term “waterproof, breathable membrane” as used herein refers to a layer that exhibits both waterproof properties (e.g., resistance to water penetration) and is breathable (e.g., the ability to transport moisture vapor away from a wearer's body to the external environment). These properties may be obtained through, for example, microperforations in the membrane. In another example, the membrane may be hydrophilic such that the membrane attracts water molecules from moisture vapor and transports the molecules through the membrane to the external environment. Aspects herein further contemplate that the waterproof, breathable membrane may have stretch and recovery properties (i.e., is elastically resilient) in at least one orientational axis, which includes both a membrane having stretch and recovery in a single orientational axis and a membrane having stretch and recovery in multiple orientational axes. Examples of an orientational axis include a length direction, a width direction, an x-direction, a y-direction, and any direction angularly offset from a length direction, a width direction, an x-direction, and a y-direction.

Some example materials used to form the waterproof, breathable membrane contemplated herein include polymers. The polymer(s) can be crosslinked. In some examples, the polymers can include an olefin. In some examples the olefin can include a polyolefin. In examples, the polyolefin can include polyethylene, polypropylene, or a combination thereof. In some examples, the polymer can comprise polyurethane (PU). In some examples, the polymer can include a thermoplastic polymer. In some examples, the polymer can include a thermoplastic elastomer. In some examples, the polymer can include a recycled polymer. In some examples, the polymer can include recycled polyurethane (rPU), thermoplastic polyurethane (TPU), recycled TPU (rTPU), thermoplastic polyether ester elastomer (TPEE), recycled TPEE (rTPEE), polytetrafluoroethylene (PTFE), recycled PTFE (rPTFE), expanded PTFE (ePTFE), and the like.

A waterproof, breathable membrane can have various forms. For instance, in some examples, a waterproof, breathable membrane can include a film (e.g., PU film). For example, the polymer can be extruded onto a carrier substrate (e.g., release paper or release film) and solidified (e.g., cured) to form a thin sheet. The carrier can then be removed when the thin sheet is combined with other textile layers.

In some examples, a waterproof, breathable membrane can include an electrospun web.

In some examples, a composite textile of the present disclosure (e.g., a nonwoven layer coupled to a membrane) can include a measure of waterproofness, which indicates a minimum amount of water pressure the composite textile can withstand without permitting the water to penetrate. In at least some examples, waterproofness is determined based on a hydrostatic head test, such as ISO 811. In examples of this disclosure, the composite textile can include a minimum rating of about 400 mm, or about 450 mm, or about 1500 mm, or about 5000 mm, or greater than 5000 mm.

In some examples, a composite textile of the present disclosure can include a measure of breathability (RET), which indicates how resistant the textile is to water vapor (e.g., lower RET indicates better breathability, allowing more vapor to pass through). In at least some examples, breathability (water vapor resistance) is determined based on ISO 11092. In examples of this disclosure, the composite textile can include a RET value that is equal to or less than about 5 RET; equal to or less than about 10 RET; equal to or less than about 15 RET; equal to or less than about 30 RET; equal to or less than about 60 RET; or equal to or less than about 75 RET.

Examples of this disclosure can refer to a printed component or a color or color property. The term “color” or “color property” as used herein refers to an observable color of fibers (i.e., fibers and/or filaments) that form the composite textile. Such aspects contemplate that a color may be any color that may be afforded to fibers using dyes, pigments, and/or other colorants that are known in the art. As such, fibers may be configured to have a color including, but not limited to red, orange, yellow, green, blue, indigo, violet, white, black, and shades thereof. In one example aspect, the color may be imparted to the fiber when the fiber is formed (commonly known as dope dyeing). In dope dyeing, the color is added to the fiber as it is being extruded such that the color is integral to the fiber and is not added to the fiber in a post-formation step. In other aspects described herein, the color may be added to the fiber after the fiber is formed and incorporated into a nonwoven textile layer. This may be done through the application of a colorant using, for example, a screen mesh gravure process, sublimation printing (e.g., via CO2 or some other medium), screen printing, padding, spraying, and the like.

Examples related to a color further contemplate determining if one color is different from another color. In these aspects, a color may comprise a numerical color value, which may be determined by using instruments that objectively measure and/or calculate color values of a color of an object by standardizing and/or quantifying factors that may affect a perception of a color. Such instruments include, but are not limited to spectroradiometers, spectrophotometers, and the like. Thus, aspects herein contemplate that a “color” of a textile provided by fibers and/or filaments may comprise a numerical color value that is measured and/or calculated using spectroradiometers and/or spectrophotometers. Moreover, numerical color values may be associated with a color space or color model, which is a specific organization of colors that provides color representations for numerical color values, and thus, each numerical color value corresponds to a singular color represented in the color space or color model.

In these aspects, a color may be determined to be different from another color if a numerical color value of each color differs. Such a determination may be made by measuring and/or calculating a numerical color value of, for instance, a first textile having a first color with a spectroradiometer or a spectrophotometer, measuring and/or calculating a numerical color value of a second textile having a second color with the same instrument (i.e., if a spectrophotometer was used to measure the numerical color value of the first color, then a spectrophotometer is used to measure the numerical color value of the second color), and comparing the numerical color value of the first color with the numerical color value of the second color. In another example, the determination may be made by measuring and/or calculating a numerical color value of a first area of a textile with a spectroradiometer or a spectrophotometer, measuring and/or calculating a numerical color value of a second area of the textile having a second color with the same instrument, and comparing the numerical color value of the first color with the numerical color value of the second color. If the numerical color values are not equal, then the first color or the first color property is different than the second color or the second color property, and vice versa.

Further, it is also contemplated that a visual distinction between two colors may correlate with a percentage difference between the numerical color values of the first color and the second color, and the visual distinction will be greater as the percentage difference between the color values increases. Moreover, a visual distinction may be based on a comparison between colors representations of the color values in a color space or model. For instance, when a first color has a numerical color value that corresponds to a represented color that is black or navy and a second color has a numerical color value that corresponds to a represented color that is red or yellow, a visual distinction between the first color and the second color is greater than a visual distinction between a first color with a represented color that is red and a second color with a represented color that is yellow.

The term “pill” or “pilling” as used herein refers to the formation of small balls of fiber ends (i.e., fiber ends and/or filament ends) on a facing side of the composite textile. The pill may extend away from a surface plane of the face. Pills are generally formed during normal wash and wear due to forces (e.g., abrasion forces) that cause the fiber ends to migrate through the face of the nonwoven textile and entangle with other fiber ends. A textile's resistance to pilling may be measured using standardized tests such as Random Tumble and Martindale Pilling tests.

As used herein, the term “chemical bonding” refers to the use of chemical binders (e.g., adhesive materials) that are used to hold fibers together, filaments together, and/or fibers and filaments together. In general, the chemical binder joins the fibers together, the filaments together, and/or the fibers and filaments together at areas where the fibers and/or filaments intersect with each other (e.g., cross each other) and bonding results. In one example aspect, the chemical binder may form an adhesive film the bonds the fibers and/or filaments together at, for example, fiber-fiber, filament-filament, and/or fiber-filament intersections. Because the fibers and/or filaments are adhered together, the terminal ends of the fibers and/or filaments are less prone to migration and pilling, and the overall pilling resistance of the composite textile is increased.

Suitable chemical binders can include those that comprise polymers and may include vinyl polymers and copolymers, acrylic ester polymers and copolymers, rubber and synthetic rubber, and natural binders such as starch. The chemical binder may be applied in an aqueous dispersion (i.e., water-based), an oil-based dispersion (or solvent-based), a foam dispersion, and the like. The term “chemical bonding site,” as used herein refers to the location of the chemical bond and it furthers refers to the chemical binder itself as applied to, for example, a nonwoven textile layer at the chemical bonding site. Examples contemplate that the chemical binder may be clear in color so as not to affect the color properties of the printed component. In some examples, the chemical binder can include a colorant (e.g., dye or pigment) so as to impart a color to a face of the composite textile.

As used herein, the term “deposit” generally means a physical material that is applied to a substrate in a continuous or discontinuous manner. Often, the deposit can be applied in a liquid form and then permitted to solidify, such as by drying, curing, and the like. The term “finish” when used herein generally refers to a material that imparts some property to a substrate (e.g., a color, water repellency, adhesion between fibers and/or filaments, wicking, and the like). In this context, a finish can be applied as a deposit (continuous or discontinuous) to a substrate.

As used in this disclosure a “wrinkle” is a surface topographical feature in which a portion of the surface is dimensionally offset in the z-direction relatively to an adjacent portion. For example, one portion that is displaced further outward in the z direction (e.g., displaced further towards an outermost position) can be referred to as a ridge portion or a peak, and an adjacent portion that is dimensionally offset inward in the z-direction (e.g., displaced, relative to the ridge, further inward and towards the membrane) can be referred to as a valley portion. In at least some examples, the ridge portion and/or the valley portion can include a longitudinal orientation (a dimension in the direction in which the ridge and/or valley extends and often times the longer dimension) and a lateral orientation (a cross dimension extending across the ridge and/or valley and often times the shorter dimension).

In at least some examples, a unit area of the composite textile can include a set of wrinkle properties (e.g., surface topography properties), such as but not limited to average wrinkle orientation, average wrinkle peak z-offset, average wrinkle valley z-offset, average wrinkle peak-to-valley z-dimension, average wrinkle length, average wrinkle width, average wrinkle density, and the like. In some examples, wrinkle properties can be quantified using one or more tools or instruments configure to scan and measure surface properties. In this disclosure, the term “unit area” can describe a portion of a textile (composite textile) used to assess properties of the textile. In some examples, a unit area can include a 1 cm×1 cm (1 cm²), although other sizes can be used, as necessary or dictated based on the property to be assessed. In some examples, a “unit volume” can be used to assess properties of a textile, and a unit volume can include a 1 cm×1 cm×n, where n is a depth or thickness associated with the textile. In some examples, n is the entire thickness of the textile or is the thickness of a layer within the textile (e.g., the thickness of a fiber web within the textile). Other dimensions of unit volumes can also be used, as necessary or dictated based on the property to be assessed.

In at least some examples, the surface topography properties are configured, such that the surface topography imparts a desired aesthetic, drape, and/or handfeel, without creating surface features prone to capture debris. For example, one or more dimensions of the surface topography can satisfy a threshold. In some instances, the threshold can include a height in the z direction, which can be limited below a threshold to limit a size (e.g., depth) of a cavity, valley, or recessed region on the surface. In some examples, the height of the peaks/ridges and/or depths of the valleys can be configured to reduce the likelihood of collecting debris.

Various measurements may be provided herein with respect to the nonwoven textile layers and the resulting composite textile. Thickness may be measured using a precision thickness gauge. To measure thickness, for example, a composite textile, a nonwoven textile layer, and/or a waterproof, breathable membrane may be positioned on a flat anvil and a pressure foot is pressed on to it from the upper surface under a standard fixed load. A dial indicator on the precision thickness gauge gives an indication of the thickness in millimeters (mm), micrometers (μm), and the like.

Basis weight can be measured using ISO 3801, Method 5 (1977 ) testing standard and has the units grams per square meter (gsm).

Textile stiffness, which generally corresponds to drape can be measured using ASTMD4032 (2008) testing standard using a pneumatic actuator and a digital gauge with a 25 Kgf capacity and has the units kilogram force (Kgf).

In examples, the composite textile's resistance to water penetration can be measured using ISO811 (1981) (commonly known as the Hydrostatic Pressure Test) and can have the units of mm. In examples, as explained in other parts of this disclosure, the term “waterproof” as used herein indicates a structure's ability to resist water penetration of a column of water of at least 400 mm.

In examples, the composite textile's resistance to vapor transport (RET), which indirectly measures the ease at which moisture vapor passes through the composite textile, can be measured using ISO 11092 (2014) with a 10 inch plate. In example aspects, the term “breathable” as used herein means that the composite textile has an RET from about 10 RET to about 75 RET. The composite textile's resistance to surface wetting, which is a measure of water repellency, can be measured using ISO4920 (2012). With respect to surface wetting, the washing condition is NAL.TM.0020V3.2, SDL Vortex M6 Washer with a 16±1 minute machine wash at 40 degrees Celsius ±3 degrees with 1.0±0.01 g/L EC detergent. The wash is done without detergent during the last wash cycle followed by a tumble dry. In examples, the BW is at least 5.0, and in some cases at least 3.0; the AW3X is at least 4.0, and in some cases at least 3.0; and the AW20X is at least 3.0.

Unless otherwise noted, all measurements provided herein are measured at standard ambient temperature and pressure (25 degrees Celsius or 298.15 K and 1 bar) with the composite textile in a resting (un-stretched) state.

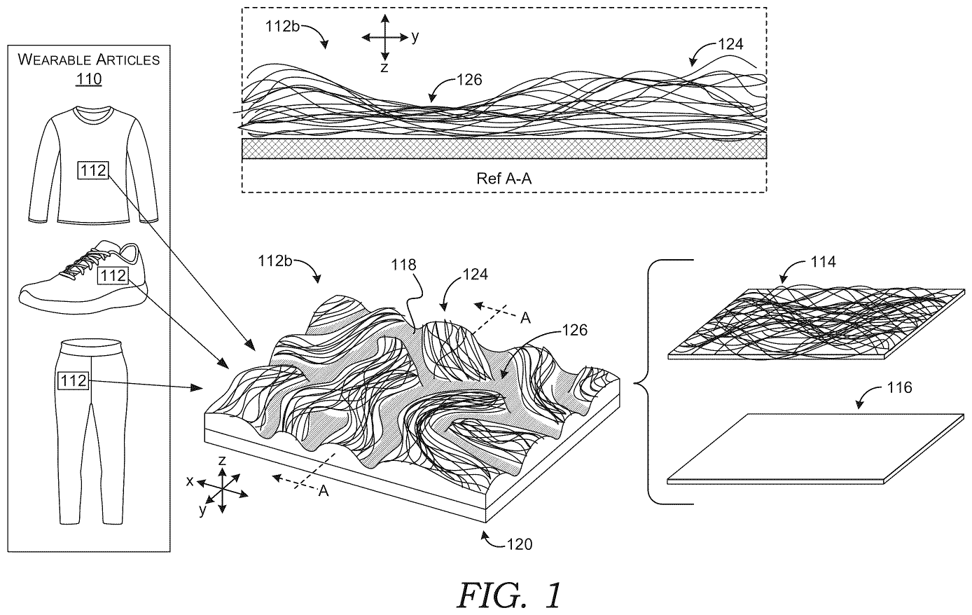

In some examples, reference can be made to a three-dimensional space including an “x” and a “y” and a “z” (e.g., axis, direction, orientation, etc.). Unless otherwise indicated, these references might not include precise relationships to one another and can refer to relative relationships. For example, x, y, and z axes are depicted in FIG. 1 to orient the composite textile to an x-y plane and a thickness in the z-direction. Any of the textiles or layers described in this disclosure can similarly be described with respect to x, y, and z.

As used herein, the terms “about” and “substantially” mean +/−10% of a given value, such as a linear dimension value (e.g., height, width, etc.) or a weight value. In addition, with respect to an angle or angular dimension, or the terms parallel and perpendicular, the terms “about” and “substantially” mean within 10 degrees. If the “about” or “substantially” is otherwise used, the terms include equivalents of the subject element, where appropriate.

Referring now to FIG. 1, FIG. 1 depicts examples of wearable articles 110, any of which can include a composite textile 112 (e.g., composite nonwoven textile), which is shown in an enlarged view of the composite textile 112b. The enlarged view of the textile 112b is not necessarily to scale. In some instances, the structures in the enlarged view could form at least part of a unit area or a unit volume. The enlarged view 112b also includes a cross-sectional view (Ref A-A), which is also shown in a further enlarged view. The portion 112c is associated with a cross-section view taken at reference line A-A. When referring to the composite textile, reference might be made to reference numbers 112, 112b, and/or 112c. In addition, FIG. 1 also includes a deconstructed view of at least some of the layers of the composite textile 112, including a nonwoven layer 114 and a membrane 116. For the purposes of illustration and clarity, the representations in FIG. 1 might omit some elements that might otherwise be present in the composite textile 112. The composite textile 112 can include various other elements, such as, but not limited to, one or more of a DWR, chemical binder (e.g., antipilling coating), colorant (e.g., CO2 sublimation printed colorant, pigment, ink, etc.), adhesive layer (e.g., between the nonwoven layer and the membrane), coating (e.g., for improved hydrostatic pressure), patterning (e.g., discontinuous deposits for anti-cling, aesthetics, etc.), or any combination thereof.

In examples, the composite textile 112 includes a first face 118, which is formed at least partially by the nonwoven layer 114, and a second face 120 that is formed at least partially by the membrane 116 (and/or one or more additional coatings that have been applied to the membrane 116). The nonwoven layer 114 can include any one or more of the types of nonwoven layers described in this disclosure (e.g., spunlace, meltblown, spunbond, staple fiber, etc.) and can include any one or more of the types of fibers (e.g., continuous-length fibers or filaments, staple fibers, etc.) with any one or more of the fiber properties described in this disclosure (e.g., compositional material, cross-sectional shape, diameter, denier, single component, multicomponent, etc.). In at least some examples, the nonwoven layer 114 includes a spunlace layer. The spunlace layer can include fibers that compositionally include polyester, such as PET, rPET, etc. The spunlace layer can include an average basis weight, and in some examples the average basis weight of the spunlace layer is in a range from about 15 gsm to about 150 gsm, or from about 20 gsm to about 125 gsm, or from about 25 gsm to about 100 gsm, or from about 27 gsm to about 75 gsm, or from about 30 gsm to about 50 gsm, or from about 35 gsm to about 45 gsm, or about 40 gsm.

The membrane 116 can include any of the membranes described in this disclosure that can impart (or contribute to) various properties of the composite 112, such as waterproofness, water resistance, breathability, etc. In some examples, the membrane 116 is a film (e.g., a cross-linked PU film that is hydrophilic for vapor transport and/or that includes micro-perforations). The film can have various basis weights, and in some instances, the film includes a basis weight in a range from about 10 gsm to about 50 gsm, or from about 12 gsm to about 40 gsm, or from about 15 gsm to about 30 gsm, or from about 16 gsm to about 25 gsm, or about 22 gsm.

The nonwoven layer 114 and the membrane 116 can be coupled in various manners. In at least some examples, the nonwoven layer 114 and the membrane 116 can be bonded together by an adhesive layer (e.g., by a polyurethane reactive (PUR) adhesive) positioned between the layers 114 and 116.

In at least some examples, the first face 118 can include an outermost-facing surface of the wearable article 110, and the second face 120 can include an innermost-facing surface of the wearable article 110. As such, the outermost-facing surface of the wearable article 110 can include the nonwoven layer 114 (e.g., predominantly include fibers making up the nonwoven layer 114), and the innermost-facing surface can include the membrane 116 (e.g., predominantly include the membrane 116 with any additional coating(s) that might be applied to the membrane 116).

In examples of this disclosure, the first face 118 can include wrinkles (e.g., varied-height surface topography) that are formed by clusters of fiber portions 124, which are displaced outward and away from the membrane 116. Stated another way, the wrinkles can include some fiber portions 124 that are offset outward relative to other fiber portions 126 in the z-direction (e.g., where first fiber portions 124 pucker outward and form a ridge or a peak and second fiber portions 126 are offset more inward and positioned closer to the membrane 116 and form a valley).

The wrinkles can have various properties. For example, a wrinkle (or a set of wrinkles) can include an orientation, a z-offset (e.g., height differential as between the portions 124 and 126), length, width, wrinkle density (e.g., number of “ridges” in a given unit area), among others. In at least some examples, the wrinkles can include one or more properties (e.g., surface-topographical properties) that can be measured by a tool or instrument configured to scan the first face 118.

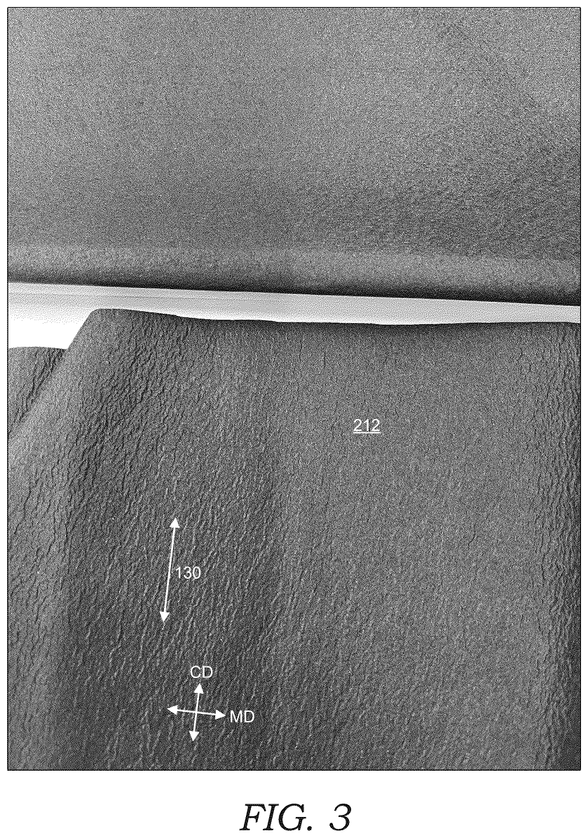

In at least some examples, the wrinkles can provide a desired surface ornamentation to the face 118 that is suitable and desired for wearable articles. For example, in at least some conventional textiles and in contrast to the composite textile 112, conventional nonwovens can have a more uniform surface with less differential offset as between various fiber portions. However, the composite textile 112 of the present invention includes (in contrast to conventional composite textiles with nonwoven layers) the wrinkles with a higher degree of dimensional offset, which can provide an interesting and unique aesthetic. Additional examples of an outermost face of the composite textile are provided in FIGS. 3 through 7.

The wrinkles can, in some instances, impart other desired properties. In examples, the wrinkles can impart a hand feel that is desirable or preferred for some apparel articles. For instance, the wrinkles can impart additional loft based on fibers 124 extending outward and adding a sense of fullness to the composite textile. In some examples, the wrinkles can contribute to a drape property that is enhanced or different as compared to a composite textile that does not include the wrinkles. For example, the fiber portions 126 can operate similar to living hinges or microfolds that can decrease the resistance of the composite textile to bending. In at least some examples, the drape or stiffness can include a measure that is equal to or less than 0.600 Kgf, or in some examples equal to or less than 0.550 Kgf, or in some examples equal to or less than 0.500 Kgf, or in some examples equal to or less than 0.450 Kgf, or in some examples equal to or less than 0.400 Kgf.

In at least some examples, wrinkles that are on the face 118 can include a longitudinal orientation (e.g., 130 in FIG. 3), and in some instances, the longitudinal orientation of a set of wrinkles (e.g., in a unit area or larger area) can extend in a similar direction. Stated differently, the set of wrinkles can be described as having a general directional pattern. For example, a ridge portion can include a longitudinal orientation that is aligned with a length of the ridge (the longer dimension) and a lateral orientation that is aligned with a width of the ridge (e.g., the shorter dimension). In addition, a valley portion can similarly include a longitudinal orientation, which in many instances aligns with the longitudinal orientation of the ridge portion. In at least some examples, the ridges of a set of wrinkles can longitudinally extend in a similar direction (e.g., 130 in FIG. 3-7).

In at least some examples the similar direction in which the ridges extend is relative to a direction associated with the composite textile. For example, in some examples, the ridges can longitudinally extend in a direction that is more aligned with a cross direction of the composite textile, as compared to a machine direction of the composite textile (e.g., “CD” and “MD” in FIGS. 3-7) . In some examples, the CD and the MD of the composite textile can also correspond with the CD and MD of the membrane 116 (e.g., of the film) and/or the CD and the MD of the nonwoven layer 114. In the context of this disclosure, MD of the composite textile is the direction in which the layers 114 and 116 are laid down when being joined into the composite, such as the direction parallel to the movement of the layers 114 and 116 and the resulting textile when moving through the manufacturing machinery. The CD of the composite textile is typically perpendicular to the MD. In some examples, the CD of the composite textile is similar to the CD of the nonwoven layer 114.

The wrinkles on the face 118 can be formed in various manners. In at least one example, and without being bound by theory, the portions 124 are displaced outward and away from the membrane 116 based on one or more performance characteristics that differ as between the nonwoven layer 114 and the membrane 116. For instance, in some examples the nonwoven layer 114 and the membrane 116 can include different shrinkage rates in response to exposure to thermal energy, such that the membrane 116 might shrink (e.g., based on exposure to temperature changes, such as hot and cold cycle(s)) at a different rate than the nonwoven layer 114. That is, in some examples, the membrane 116 (e.g., PU film) can be less resistant (more prone) to temperature-induced shrinking, and as such, when the membrane 116 shrinks (more than the nonwoven layer 114) when exposed to a thermal energy, the fibers of the nonwoven layer 114 are displaced outward. In at least some examples, the differences in resistance to temperature-induced shrinking between the nonwoven layer 114 and the membrane 116 can be based on the differences in one or more properties, such as structure (e.g., film form as compared to fiber form), composition (e.g., PU as compared to polyester), etc. In at least some examples, the membrane 116 might shrink more in the MD direction (as compared to the CD direction), which in turn can contribute to the wrinkles (e.g., the ridges of the wrinkles) aligning more in the CD.

In at least some instances, the wrinkles on the face 118 can arise from a difference in the recovery properties of the nonwoven layer 114 as compared to the membrane 116. For example, over time, the nonwoven layer 114 might relax more than the membrane 116 and/or might experience more growth than the membrane 116. In some examples, the nonwoven layer 114 might recover from a tensioned state to a lesser extent than membrane 116. For example, the layers might be placed into a tensioned state in various contexts, such as when being treated (e.g., steam treated, washed, dried, printed, gravure treated, calendared, solution bath, etc.), and post treatment, the nonwoven layer 114 might recover less than the membrane.

In at least some examples, the wrinkles on the face 118 can become more defined over time, which can impart a desired “reveal effect” to the composite textile 112. That is, the face 118 of the composite textile 112 might have an initial surface topography that includes some wrinkles, or even minimal to no wrinkles. Over time, such as with repeated wear and/or exposure to thermal energy (e.g., through washing, drying, etc.), wrinkles can become more defined on the face 118, such as where additional wrinkles are formed, differentials between 124 and 126 increase, etc. This wrinkle reveal effect can provide various advantages. For example, the dynamic nature of the wrinkle properties over time can provide an interesting aesthetic for a wearable article. In some examples, the more defined wrinkles over time can contribute to a broken-in feel, such as by progressively improving drape, handfeel (e.g., loftiness, softness, etc.) over time.

In at least some examples, the nonwoven layer 114 is coupled to a first side of the membrane 116, and another textile layer can be coupled to the opposing side of the membrane 116. For example, a knit textile, woven textile, nonwoven textile, or other textile or substrate can be coupled to the opposing side. In some examples, the other textile layer can include a second nonwoven layer. The second nonwoven layer can, in some instances, include at least some properties that are similar to the nonwoven layer 114. For example, the second nonwoven layer can include a similar type of nonwoven (e.g., spunlace, meltblown, spunbond, staple fiber, etc.); one or more similar fibers properties; and a similar basis weight. In some examples, the second nonwoven layer can include surface topographical properties (e.g., wrinkles) that are similar to the nonwoven layer 114.

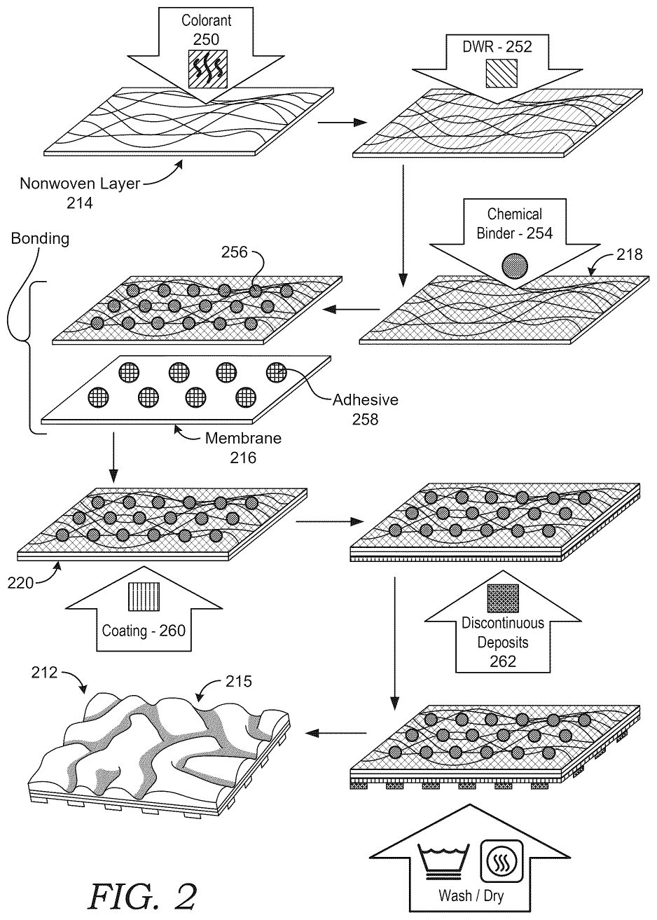

Referring now to FIG. 2, additional examples are described with respect to a composite textile 212, which can include any one or more (e.g., all) of the properties described with respect to FIG. 1 and textile 112. In some examples, the elements described with respect to FIG. 2 are associated with a method of constructing the composite textiles 110 and 212. In addition, the subject matter described with respect to FIG. 2 can also refer to the structure of (and can support claims related to) the composite textiles 110 and 212 and/or to parts or portions of the composite textiles 110 and 212.

In at least some examples, the composite textile 212 can include the nonwoven layer 214. The nonwoven layer 214 can include any nonwoven layer described in this disclosure. In some examples, the nonwoven layer 214 can include a spunlace textile. The spunlace textile can include various compositions, including polyester, such as PET, rPET, etc. In some instances, the spunlace textile can have an average basis weight, and in some examples the average basis weight of the spunlace layer is in a range from about 15 gsm to about 150 gsm, or from about 20 gsm to about 125 gsm, or from about 25 gsm to about 100 gsm, or from about 27 gsm to about 75 gsm, or from about 30 gsm to about 50 gsm, or from about 35 gsm to about 45 gsm, or about 40 gsm. Targeting a basis weight in this range for the spunlace textile can contribute to the resulting composite textile 212 having a basis weight in a desired range after the nonwoven layer 214 is combined with the membrane 216. Moreover, targeting a basis weight in this range for the spunlace textile can provide a stable substrate that is less prone to tearing during subsequent processing. In addition, targeting a basis weigh in this range can increase the likelihood that the composite textile will include a desired wrinkle surface finish.

In example aspects, the fibers and/or filaments of the nonwoven layer 214 may include polyester (e.g., PET) fibers (recycled or virgin) although other virgin and recycled fiber types are contemplated herein (e.g., polyamide, cotton, and the like). In one example aspect, the fibers and/or filaments may include 100% by weight of recycled fibers such as 100% by weight of recycled polyester fibers. However, in other aspects, the fibers and/or filaments may include 100% by weight virgin fibers, or other combinations of virgin and recycled fibers, as desired. In some examples, the fibers can include a blend of fibers.

In some examples, the fibers can be continuous, such as when formed by a melt-blown process and/or spunbond process. In some examples, the fibers may comprise a uniform length such as when the fibers are formed from virgin extruded polyester or re-pelletized polyester and cut to a defined length. In other aspects, the fibers may include a variation of staple length and can also include clumps of shredded article, such as when the fibers are derived from a shredded-article fiber source.

The nonwoven layer 214 can be processed in various manners. In at least some examples, the nonwoven layer 214 (e.g., the fibers of the nonwoven layer 214) can be embedded, infused, or impregnated with a colorant 250. For example, the fibers or filaments can be dope dyed or impregnated with a colorant via sublimation printing (e.g., via CO2 (SC-CO2) or some other fluid medium). These are non-limiting examples, and the nonwoven layer 214 can include alternative colorant or additional colorant added via one or more other methods.

In addition, the nonwoven layer 214 can be treated with a DWR solution 252. For example, a padding process can be carried out, such as a stamp padding process or a bath padding process. Other application methods known in the art, including additional types of padding systems, spray systems, and the like, are contemplated herein and can be used to treat the nonwoven textile 214 with the DWR. In examples after the padding process (or other DWR application process), at least about 50%, at least about 60%, at least about 70%, at least about 80%, at least about 90%, or at least about 100% of the surface area of one or both sides of the nonwoven textile 214 can include a durable water repellant deposit. Some examples contemplate that the durable water repellant deposit may be primarily located on one side of the nonwoven layer 214. In some examples, the durable water repellant may at least partially penetrate the nonwoven layer 214 such that the durable water repellant deposit may be at least partially located in the volume between the sides of the nonwoven layer 214.

In at least some examples, the nonwoven layer 214 can be treated with a chemical binder 254. For example, a gravure system can be used to apply deposits of chemical binder 256 to at least the outer face 218 of the nonwoven textile. The chemical binder can, in some examples, reduce the likelihood of pilling on the face of the nonwoven textile. In addition, the chemical binder can, in some cases, include a colorant (e.g., dye) that can be used to impart color properties to the face of the nonwoven textile 214. In some examples, the chemical binder can be clear, transparent, or otherwise not have any dye or pigment.

Various gravure systems can be used to apply the chemical binder 254 and 256. In some examples, the gravure system can include a screen roller adapted to rotate in a first direction and the screen roller has a number of openings. Stated differently, examples of this disclosure contemplate a discontinuous application of the chemical binder 254 to generate a plurality of discrete chemical bonding sites (e.g., the chemical bonding sites 256). The number of openings per one linear inch may be selected to achieve a desired amount of coverage of the chemical binder 254 and 256 while still preserving the hand and drapability.

In example aspects, a viscosity of the chemical binder 254 before application may be selected to achieve a desired level of penetration into the nonwoven layer 214 after application. In addition, the screen roller may be adapted to apply a certain amount of pressure and heat to the nonwoven layer 214. The amount of pressure supplied by the screen roller is generally sufficient to ensure that an entirety of the face of the nonwoven textile 214 is brought into contact with the screen roller such that an even coverage of the chemical binder is applied to the face in a pattern corresponding to the number of openings per linear inch of the screen roller.

As stated, the chemical binder 254 and 256 acts as an adhesive helping to secure fibers and/or filaments together in areas where it is applied. Because the fibers and/or filaments are adhered together, the terminal ends of, for example, the fibers and/or filaments are less prone to pilling and the overall pilling resistance of at least the face of the nonwoven layer 214 is increased.

In at least some examples, the nonwoven textile 214 (e.g., the nonwoven textile 214 that has been treated with one or more of the colorant 250, the DWR 525, and the chemical binder 254) is coupled to the membrane 216. In examples, the membrane 216 is a breathable, waterproof membrane 216. The membrane 216 can include various types of material layers, such as a spunbond layer, a meltblown layer, an electrospun layer, a film, and the like. In example aspects, the membrane 216 may have a thickness from about 10 μm to about 30 μm, from about 15 μm to about 25 μm, or about 20 μm or about 18 μm. In example aspects, the membrane 216 may have a basis weight from about 10 gsm to about 50 gsm, or from about 12 gsm to about 40 gsm, or from about 15 gsm to about 30 gsm, or from about 16 gsm to about 25 gsm, or about 22 gsm. The membrane 216 may comprise a PU, an rPU, a TPU, an rTPEE, or an rPTFE material, ePTFE, or any other materials described in this disclosure associated with the membrane 116.

In at least some examples, the nonwoven textile 214 is bonded to the membrane 216 via an adhesive 258. For example, the bonding may be achieved through use of an adhesive film or liquid that is positioned between nonwoven layer 214 and the membrane 216. In example aspects, the adhesive can include a PUR adhesive, such as in a film, a liquid form, or other adhesive form. In some examples, the adhesive can be hydrophilic (e.g., hydrophilic PUR adhesive), which can contribute to breathability (e.g., by allowing vapor transport). In some examples, the adhesive can be applied as a continuous layer. In some examples, the continuous layer can include a constant thickness. In some examples, the thickness of the adhesive layer can vary, such as where the adhesive layer includes a first thickness in one region and a second thickness in a second region, where the first thickness is thicker than the second thickness.

In at least some examples, adhesive can be arranged between the nonwoven textile 214 and the membrane 216 in a layout of discontinuous shapes (e.g., lines or dots, which can also be referred to as dot lamination or dot-glue lamination). The layout can include a rule-based pattern following repeating spacing, sizing, etc. or can include a random with varied spacing, sizing, etc. In at least some examples, the thickness of the adhesive is discontinuous, such that the adhesive layer thickness is non-uniform with gaps, breaks, or regions without adhesive—the adhesive can be located in patches, islands, or include other irregular coverage. This can include any bonding methodology in which discontinuous deposits of adhesive (e.g., PUR adhesive) are applied between the nonwoven layer 214 and the membrane 216 and then cured. In at least some examples, applying the adhesive in an arrangement of discontinuous deposits can contribute to the composite textile 212 having better handfeel and drape and better breathability. In addition, applying the adhesive in an arrangement of discontinuous deposits can, in some cases, contribute to the formation of larger wrinkles, since fewer fibers are constrained and held closer to the membrane (e.g., more fibers are free of the adhesive 258 and free to be displaced in the z-direction away from the membrane). In some examples, the layout of discontinuous adhesive material deposits can contribute to the ridges having a branched arrangement and/or two or more ridges that are connected by an intermediate ridge.

In at least some examples, the inner face 220 of the membrane 216 can be treated with one or more additional material coatings and/or deposits (e.g., 260 and 262), which can be configured to face or orient towards a wearer when the apparel article is worn. In some examples, the material deposit can impart various characteristics, such as color, aesthetic patterning, anti-cling, and the like. The material deposit can be applied using various techniques, such as via gravure, spray, screen, ink head, etc. In addition, the material deposits can be applied at various temperatures, including room temperature.

In at least some examples, a coating 260 (e.g., top coat) can be applied to the inner face 220 of the membrane 216. The coating 260 can, among other things, improve the hydrostatic pressure ratings of the composite textile 212. In some examples, the coating 260 can include a PU-based coating (polyurethane-based coating). In addition, the coating 260 can be applied to provide a first amount of coverage (e.g., area) relative to the inner face 220, including at least 50%, at least 60%, at least 70%, at least 80%, at least 90%, or about 100%.

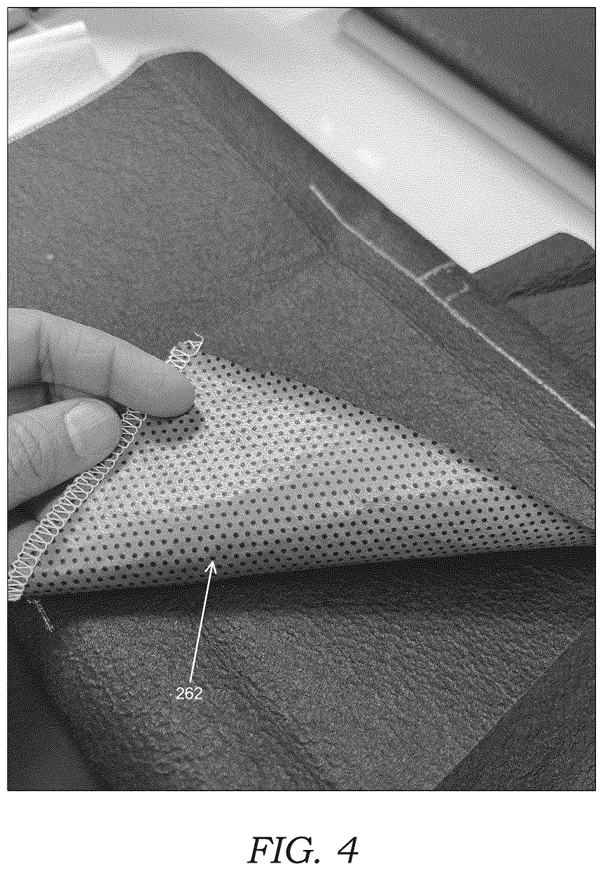

In at least some examples, discontinuous material deposits 262 can be applied to the inner face 220. For example, when the coating 260 is omitted, the discontinuous material deposits 262 can be applied directly to the inner face 220. In some examples that include the coating 260, the discontinuous material deposits 262 can be applied onto the coating 260, which is on the inner face 220. In examples, the discontinuous material deposits 262 can include a PU-based polymer or any other type of polymer (binder) that is compatible with the coating 260 (e.g., PU coating). The discontinuous material deposits 262 can, among other things, provide anti-cling and/or standoff properties to the inner face. The discontinuous material deposits 262 can include a pattern, such as a grid of dots or lines or other shapes (e.g., repeating shapes) that include at least some spacing (e.g., consistent spacing) between the deposits. In examples, the discontinuous material deposits 262 can be applied to provide a second amount of coverage (e.g., area) relative to the inner face 220, including at least 50%, at least 60%, at least 70%, at least 80%, and at least 90%. In examples that include the coating 260, the second amount of coverage of the discontinuous material deposits 262 is less than the first amount of coverage of the coating 260. An example of the discontinuous material deposits 262 is also shown in FIG. 4.

In at least some examples, the discontinuous material deposits 262 can impart a desired aesthetic to the inner face (e.g., the second face 120). For example, the discontinuous material deposits 262 can include a different color and/or a different sheen as compared to an underlying layer, such as the coating 260 and/or the membrane 216. In some examples, the discontinuous material deposits 262 can impart a contrasting aesthetic and visual quality as compared to the outer surface (e.g., 118), which can include the varied surface topography imparting the wrinkle surface texture. In this sense, the composite textile 212 can include an asymmetric-faced composite textile with the outer surface having the wrinkle-like, varied surface topography and the inner surface including the pattern of discontinuous material deposits (e.g., consistently sized and spaced pattern of discontinuous material deposits).

In at least some examples, the composite textile that includes the nonwoven layer 212 coupled to the membrane 216 (and any one or more of the other elements 250, 252, 254, 260, and 262), can be heated and cooled, such as resulting from one or more wash and dry cycles. For example, the composite textile can be washed at a temperature in a range of 35 degrees Celsius to about 45 degrees Celsius and dried at a temperature in a range of about 60 degrees Celsius to about 70 degrees Celsius. In examples of the present disclosure, the membrane 216 can, when exposed to the temperature changes, shrink at a different rate as compared to the nonwoven textile 214, which can create wrinkles 215 on at least the first face 218, formed by fiber portions that are displaced away from the membrane 216.

In some examples, one or more of the elements or operations of FIG. 2 can be modified or omitted. In addition, one or more elements or operations can be added. In at least some examples, another textile layer can be coupled to the face 220 of the membrane 216. For example, a knit textile, woven textile, nonwoven textile, or other textile or substrate can be coupled to the inner face 220. In some examples, the other textile layer can include a second nonwoven layer. The second nonwoven layer can, in some instances, include at least some properties that are similar to the nonwoven layer 214. For example, the second nonwoven layer can include a similar type of nonwoven (e.g., spunlace, meltblown, spunbond, staple fiber, etc.); one or more similar fibers properties; and a similar basis weight. In some examples, the second nonwoven layer can include surface topographical properties (e.g., wrinkles), which can in some instances be similar to the nonwoven layer 214.

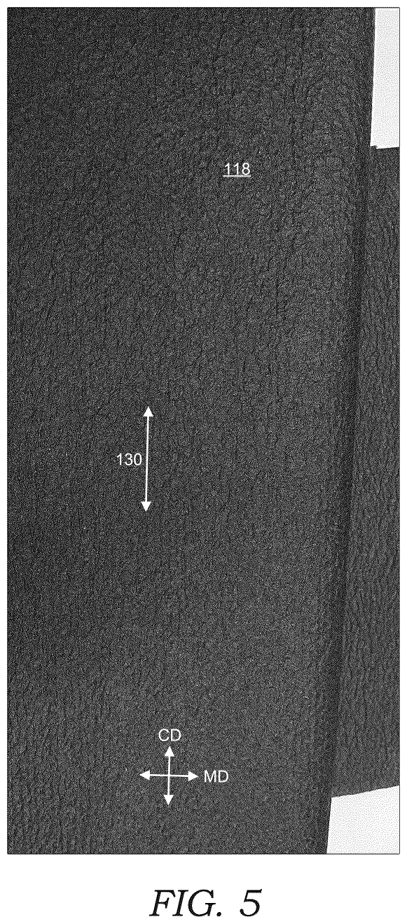

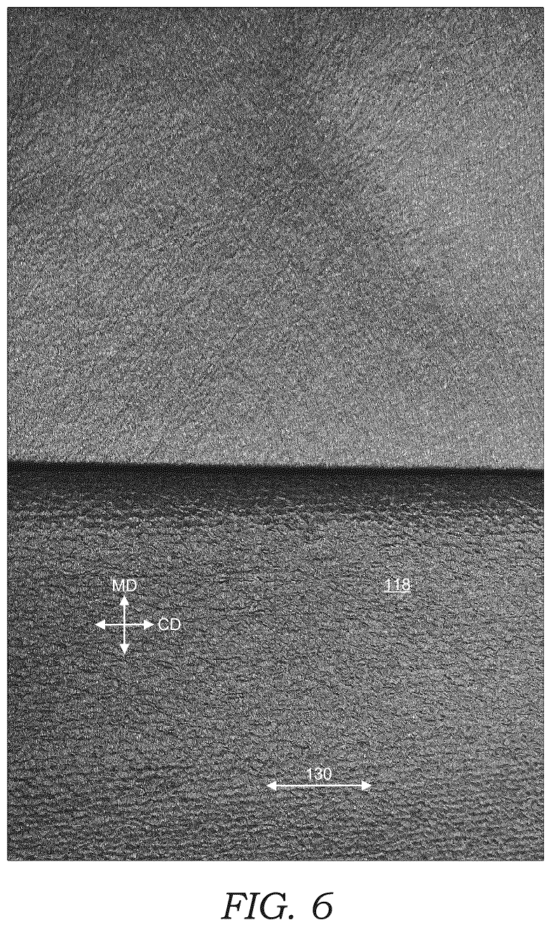

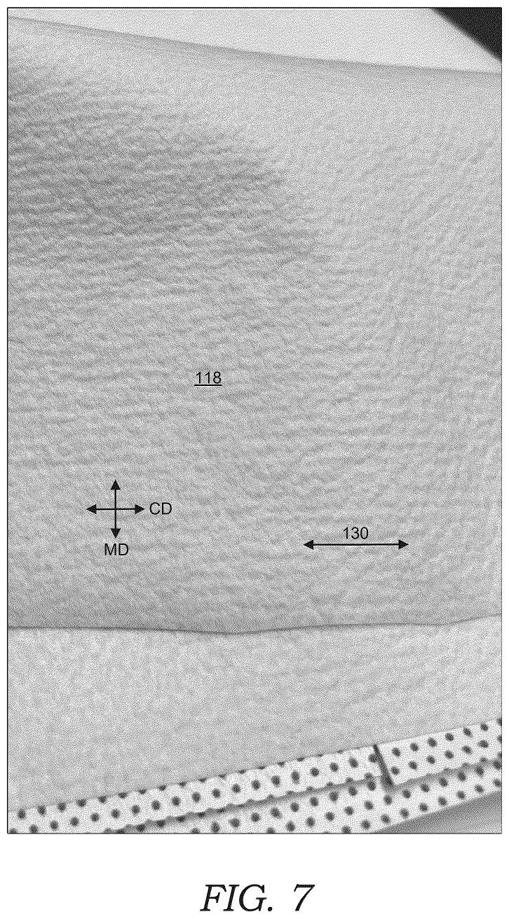

Referring to FIG. 3, FIG. 5, FIG. 6, and FIG. 7, composite textiles are depicted, which can include any of the properties of the composite textiles 112 and 212. The composite textiles includes a first face 118, which can form an outermost facing surface of an apparel article. The first face 118 includes wrinkles having a longitudinal orientation 130 aligned in the CD of the composite textile.

Referring to FIG. 4, a composite textile is depicted, such as composite textiles 112 and 212, and the composite textile in FIG. 4 includes a second face that can form an innermost facing surface of an apparel article and that includes discontinuous deposits 262, which can be applied to the membrane 216 or to the coating 260. The discontinuous deposits 262 can include a dot pattern or other discontinuous pattern, such as lines, grids, etc., which can include a repeating pattern of one or more consistently shaped deposits that are regularly spaced apart. In some examples, the discontinuous deposits 262 can have one or more other shapes and/or one or more other varied spacings. In some examples, the discontinuous deposits 262 can include a random layout with inconsistent spacing.

In examples of the present disclosure, any of the composite textiles described in this disclosure, such as composite textiles 112 and 212, can include a surface texture (e.g., on the first face 118) having surface-texture properties that are quantifiable. For example, surface-texture properties (e.g., on the first face 118) can be quantified using any suitable equipment, tools, or instruments, such as a 3D scanner, optical profilometer (e.g., confocal microscopy, white light interferometry, focus variation, etc.); a stylus profilometer (e.g., contact-based stylus tracing); or other surface-analysis equipment (e.g., multi-sensor profiler). In some instances, surface-texture properties can be measured as a profile along a line extending across a sample, such as by a stylus or laser. In some instances, surface-texture properties can be measured across an area of a sample. In some examples, the surface-texture properties can be quantified pursuant to ISO 21920-2:2021 or a similar testing standard.

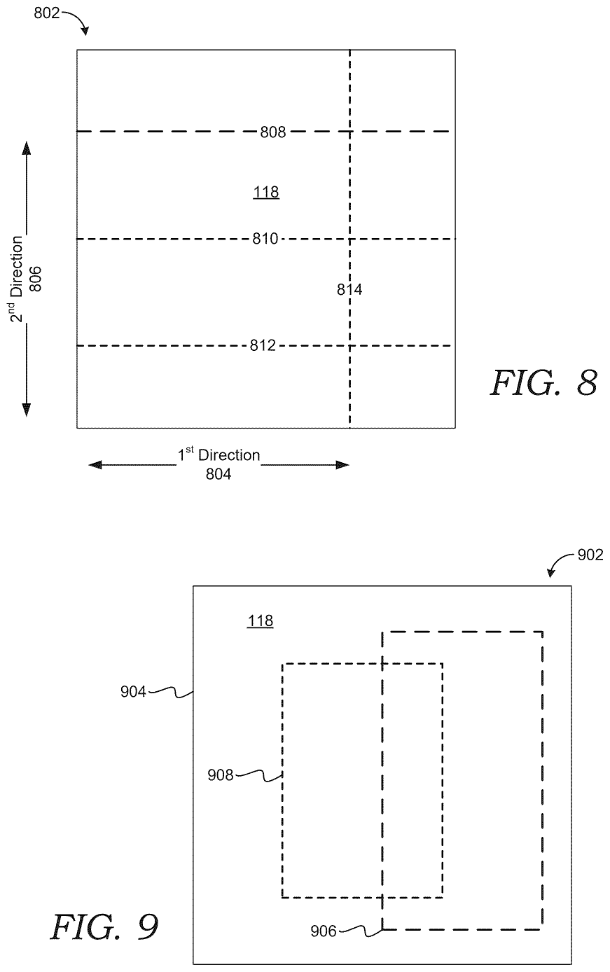

In some examples, surface-texture properties of the first face 118 can be quantified using a sample of a composite textile (e.g., 5 cm×5 cm swatch), such as by measuring along one or more profile lines generally extending in a first direction, by measuring along one or more profile lines generally extending in a second direction perpendicular to the first direction, or by measuring along both one or more profile lines generally extending in the first direction and one or more profile lines generally extending in the second direction. For example, FIG. 8 depicts an example of a sample 802 of a composite textile, which can include any of the composite textiles described with respect to the composite textiles 112 and 212. The sample 802 includes the first face 118 (e.g., the face formed by the nonwoven layer 114), and the sample 802 is associated with a first direction 804 and a second direction 806, which is perpendicular to the first direction 804.

In some examples, surface-texture properties of the first face 118 of the sample 802 can be measured along one or more profile lines 808, 810, and/or 812 generally extending in the first direction 804, by measuring along one or more profile lines 814 generally extending in the second direction 806 perpendicular to the first direction 804, or by measuring along both one or more profile lines 808, 810, and/or 812 generally extending in the first direction 804 and one or more profile lines 814 generally extending in the second direction 806.

In some examples, the first direction 804 can be aligned more with the CD of the composite textile than with the MD of the composite textile, and the second direction 806 can be aligned more with the MD of the composite textile than with the CD of the composite textile.

Various surface-texture properties of the first face 118 can be quantified. For example, across a profile, surface-texture properties of the first face 118 can include, but are not limited to, arithmetical mean height or roughness (Ra), average maximum profile height between peaks and valleys (Rz), mean spacing of profile irregularities from one wrinkle to an adjacent wrinkle (RSm), maximum profile peak height (Rp), maximum profile valley depth (Rv), and the like. Each of these values can be used to assess the topographical properties of a surface and to understand the quality and/or character of the surface wrinkles.

In examples arithmetical mean height or roughness (Ra) can include the arithmetic average of the absolute values of the surface profile deviations from the mean line over the evaluation length and can indicate a general sense for how wrinkly the surface is, where a higher Ra suggests more pronounced wrinkles overall.

In at least some examples of the present disclosure, a composite textile of this disclosure (e.g., the composite textile 112 and/or 212) can include, relative to the first face 118, an Ra in a range of about 5 μm to about 450 μm, or from about 10 μm to about 400 μm, or from about 15 μm to about 350 μm, or from about 20 μm to about 300 μm, or from about 20 μm to about 200 μm, or from about 25 μm to about 250 μm, or from about 30 μm to about 200 μm, or from about 35 μm to about 150 μm, or from about 40 μm to about 100 μm, or from about 45 μm to about 70 μm, or from about 50 μm to about 65 μm.

In at least some examples of the present disclosure, a composite textile of this disclosure (e.g., the composite textile 112 and/or 212) can include, relative to the first face 118, a first Ra measured along a profile (e.g., 808, 810, or 812) extending in the first direction 804 that is different than a second Ra measured along a profile (e.g., 814) in the second direction 806. In some examples, the first direction 804 can be more aligned with the CD of the composite textile; the second direction 806 can be more aligned with the MD of the composite textile; and the Ra in the first direction 804 is smaller than the Ra in the second direction. Without being bound by theory, the difference in Ra values in the CD versus the MD can possibly relate to wrinkles being more oriented in the composite textile CD, in which case a higher quantity of wrinkles is along the profile line(s) in the composite textile MD indicating a more wrinkly surface.

In some examples, the Ra that is associated with the first direction 804 and/or the second direction 806 can be based on an average Ra of a plurality of Ra measurements, each Ra measurement taken along a different profile line extending in the respective direction.

In examples average maximum profile height between peaks and valleys (Rz) can include the average of the vertical distance between the peaks and the valleys within some number of sampling lengths (e.g., 5 sampling lengths) and can indicate how extreme the wrinkling is, where a higher Rz suggests deeper and/or taller wrinkles.

In at least some examples of the present disclosure, a composite textile of this disclosure (e.g., the composite textile 112 and/or 212) can include, relative to the first face 118, an Rz in a range of about 150 μm to about 500 μm, and in some examples in a range of about 200 μm to about 450 μm, and in some examples in a range of about 250 μm to about 425 μm, and in some examples in a range of about 300 μm to about 400 μm. In some examples, the Rz can be greater than 500 μm. In some examples, the Rz can be less than 500 μm. In some examples, the size of the Rz is controlled (e.g., maintained less than 500 μm) to control a size of the varied surface topography. For example, configuring an Rz less than 500 μm, and in some examples less than 450 μm or less than 400 μm, can contribute to shallower recesses (e.g., valleys) on the surface, which can reduce the likelihood of debris (e.g., dirt, dust, VOCs, stains, etc.) being captured by the composite textile.

In at least some examples of the present disclosure, a composite textile of this disclosure (e.g., the composite textile 112 and/or 212) can include, relative to the first face 118, a first Rz measured along a profile (e.g., 808, 810, or 812) extending in the first direction 804 that is different than a second Rz measured along a profile (e.g., 814) in the second direction 806. In some examples, the first direction 804 can be more aligned with the CD of the composite textile; the second direction 806 can be more aligned with the MD of the composite textile; and the Rz in the first direction 804 is smaller than the Rz in the second direction. Without being bound by theory, the difference in Rz values in the CD versus the MD can possibly relate to wrinkles being more oriented in the composite textile CD, in which case the profile line in the second direction 806 might be more likely to pass through a larger quantity of wrinkle peaks and valleys, as compared to the profile line in in the first direction 804, which might pass through fewer peaks and valleys and/or more along portions of the wrinkles that are between the peaks and valleys (e.g., along the side of the wrinkle between the peak and valley).

In some examples, the Rz that is associated with the first direction 804 and/or the second direction 806 can be based on an average Rz of a plurality of Rz measurements, each Rz measurement taken along a different profile line extending in the respective direction.

In examples mean spacing of profile irregularities (RSm) can include the mean spacing between profile irregularities (e.g., peaks and valleys) within the evaluation length and can indicate how frequent wrinkles occur, where a smaller RSm suggests tightly packed wrinkles and a larger RSm indicates broader, more spaced-out wrinkles.

In at least some examples of the present disclosure, a composite textile of this disclosure (e.g., the composite textile 112 and/or 212) can include, relative to the first face 118, an Rsm in a range of about 3,000 μm to about 14,000 μm, and in some examples in a range of about 5,000 μm to about 13,000 μm, and in some examples in a range of about 7,000 μm to about 12,000 μm. In some examples, the Rsm can be less than 3,000 μm or greater than 14,000 μm.

In at least some examples of the present disclosure, a composite textile of this disclosure (e.g., the composite textile 112 and/or 212) can include, relative to the first face 118, a first Rsm measured along a profile (e.g., 808, 810, or 812) extending in the first direction 804 that is different than a second Rsm measured along a profile (e.g., 814) in the second direction 806. In some examples, the first direction 804 can be more aligned with the CD of the composite textile; the second direction 806 can be more aligned with the MD of the composite textile; and the Rsm in the first direction 804 is greater than the Rsm in the second direction 806. Without being bound by theory, the difference in Rsm values in the CD versus the MD can possibly relate to wrinkles being more oriented in the composite textile CD, in which case the profile line in the second direction 806 might be more likely to pass through a series wrinkle peaks and valleys that are arranged closer one another along the profile line (i.e., smaller Rsm), as compared to the profile line in in the first direction 804.

In some examples, the Rsm that is associated with the first direction 804 and/or the second direction 806 can be based on an average Rsm of a plurality of Rsm measurements, each Rsm measurement taken along a different profile line extending in the respective direction.

In examples maximum profile peak height (Rp) can include the height of the highest peak above the mean line within the evaluation length and can indicate or identify sharp and/or isolated wrinkles.

In at least some examples of the present disclosure, a composite textile of this disclosure (e.g., the composite textile 112 and/or 212) can include, relative to the first face 118, an Rp a range of about 50 μm to about 450 μm, and in some examples in a range of about 100 μm to about 400 μm, and in some examples in a range of about 125 μm to about 350 μm, and in some examples in a range of about 150 μm to about 300 μm, and in some examples in a range of about 160 μm to about 250 μm, and in some examples in a range of about 170 μm to about 200 μm, and in some examples in a range of about 180 μm to about 190 μm.

In at least some examples of the present disclosure, a composite textile of this disclosure (e.g., the composite textile 112 and/or 212) can include, relative to the first face 118, a first Rp measured along a profile (e.g., 808, 810, or 812) extending in the first direction 804 that is different than a second Rp measured along a profile (e.g., 814) in the second direction 806. In some examples, the first direction 804 can be more aligned with the CD of the composite textile; the second direction 806 can be more aligned with the MD of the composite textile; and the Rp in the first direction 804 is smaller than the Rp in the second direction. Without being bound by theory, the difference in Rp values in the CD versus the MD can possibly relate to wrinkles being more oriented in the composite textile CD, in which case the profile line(s) along the MD likely pass through a larger number of highest most peaks as compared to the profile line(s) along the CD, which potentially pass to a larger extent through a part of the wrinkle(s) that is lower than the highest most peak (e.g., between the peak and valley and along a “side” of the wrinkle).

In some examples, the Rp that is associated with the first direction 804 and/or the second direction 806 can be based on an average Rp of a plurality of Rp measurements, each Rp measurement taken along a different profile line extending in the respective direction.

In examples maximum profile valley depth (Rv) can include the depth of the deepest valley below the mean line within the evaluation length and can indicate deeper wrinkles.

In at least some examples of the present disclosure, a composite textile of this disclosure (e.g., the composite textile 112 and/or 212) can include, relative to the first face 118, an Rv a range of about 50 μm to about 450 μm, and in some examples in a range of about 60 μm to about 400 μm, and in some examples in a range of about 70 μm to about 350 μm, and in some examples in a range of about 80 μm to about 300 μm, and in some examples in a range of about 100 μm to about 250 μm, and in some examples in a range of about 125 μm to about 225 μm, and in some examples in a range of about 150 μm to about 200 μm.

In at least some examples of the present disclosure, a composite textile of this disclosure (e.g., the composite textile 112 and/or 212) can include, relative to the first face 118, a first Rv measured along a profile (e.g., 808, 810, or 812) extending in the first direction 804 that is different than a second Rv measured along a profile (e.g., 814) in the second direction 806. In some examples, the first direction 804 can be more aligned with the CD of the composite textile; the second direction 806 can be more aligned with the MD of the composite textile; and the Rv in the first direction 804 is smaller than the Rv in the second direction. Without being bound by theory, the difference in Rv values in the CD versus the MD can possibly relate to wrinkles being more oriented in the composite textile CD, in which case the profile line(s) along the MD likely pass through a larger number of lowest most valleys as compared to the profile line(s) along the CD, which potentially pass to a larger extent through a part of the wrinkle(s) that is above the lowest most valley (e.g., between the peak and valley and along a “side” of the wrinkle).

In some examples, the Rv that is associated with the first direction 804 and/or the second direction 806 can be based on an average Rv of a plurality of Rv measurements, each Rv measurement taken along a different profile line extending in the respective direction.

In at least some examples, across a surface area, surface-texture properties of the first face 118 can include, but are not limited to, Arithmetical Mean Height (Sa), Maximum Height (Sz), surface area ratio (Sdr), skewness (Ssk), texture aspect ratio (Str), arithmetic mean peak curvature (Spc), and the like. In examples, referring to FIG. 9, these measurements can be taken relative to an area associated with a sample 902 of the composite textile (e.g., 5 cm×5 cm sample), such as any of the composite textiles described with respect to 112 and/or 212, where the sample 902 includes the first face 118. For example, a first area 904 includes the entire face 118 of the sample 902, a second area 906 includes an area entirely within the first area 904, and a third area 908 includes another area that is entirely within the first area 904 and that partially overlaps the second area 906. The sample 902 can be the same sample as the sample 802.

In examples Arithmetical Mean Height (Sa) can include the average height of the wrinkles in the area relative to the mean height of the surface, where a higher Sa can indicate deeper or more pronounced wrinkles.

In at least some examples, a composite textile of this disclosure (e.g., the composite textile 112 and/or 212) can include, along the first face 118, an Sa across a surface area (e.g., a 5 cm×5 cm area or any of the areas 904, 906, or 908) in a range from about 5 μm to about 450 μm, or from about 10 μm to about 400 μm, or from about 15 μm to about 350 μm, or from about 20 μm to about 300 μm, or from about 25 μm to about 250 μm, or from about 30 μm to about 200 μm, or from about 35 μm to about 150 μm, or from about 40 μm to about 100 μm, or from about 45 μm to about 70 μm, or from about 50 μm to about 65 μm, or from about 58 μm to about 62 μm, or in some examples about 61 μm. In some examples, the Sa is an average Sa based on a plurality of different areas of the surface, such as the first area 904, the second area 906, and the third area 908.

In examples Maximum Height (Sz) can indicate a distance from the tallest wrinkle peak in the area to the deepest valley in the area, where a higher Sz can indicate more extreme wrinkling.

In at least some examples, a composite textile of this disclosure (e.g., the composite textile 112 and/or 212) can include, along the first face 118, an Sz across a surface area (e.g., a 5 cm×5 cm area or any of the areas 904, 906, or 908). The composite textile can include an average Sz based on a plurality of different areas of the surface, such as the first area 904, the second area 906, and the third area 908. In some examples, the Sz (or the average Sz) is in a range from about 300 μm to about 800 μm, or from about 350 μm to about 750 μm, or from about 400 μm to about 700 μm, or from about 450 μm to about 650 μm, or from about 500 μm to about 600 μm, or in some examples about 525 μm to about 575 μm, or in some examples about 565 μm. In some examples, the Sz or the average Sz can be in a range from about 200 μm to about 450 μm, and in some examples in a range of about 250 μm to about 425 μm, and in some examples in a range of about 300 μm to about 400 μm.

In at least some examples, the average Sz is controlled (e.g., by maintaining below a threshold value) to reduce the likelihood that the valleys trap debris (e.g., dirt, dust, VOCs, stains, etc.). In some examples, the threshold is 600 μm, and in some examples the threshold is 500 μm, and in some examples the threshold is 450 μm.

In examples surface area ratio (Sdr) can indicate how much the surface area increases (as a percentage) due to texture, where a higher Sdr can indicate more intricate wrinkling.

In at least some examples, a composite textile of this disclosure (e.g., the composite textile 112 and/or 212) can include, along the first face 118, an Sdr across a surface area (e.g., a 5 cm×5 cm area or any of the areas 904, 906, or 908) in a range of about 0.050 to about 0.070, or in some examples about 0.055 to about 0.065, or in some examples about 0.06.

The composite textile can include an average Sdr based on a plurality of different areas of the surface, such as the first area 904, the second area 906, and the third area 908. In at least some examples, the average Sdr is in a range of about 0.050 to about 0.070, or in some examples about 0.055 to about 0.065, or in some examples about 0.06.

In some examples skewness (Ssk) can measure the measure of the asymmetry of the surface height distribution and can indicate whether the surface has more peaks (positive) or valleys (negative), where negative Ssk can indicate valley-like wrinkles and positive Ssk can indicate peak-like wrinkles.

In at least some examples, a composite textile of this disclosure (e.g., the composite textile 112 and/or 212) can include, along the first face 118, an Ssk across a surface area (e.g., a 5 cm×5 cm area or any of the areas 904, 906, or 908) that is positive. For example, the Ssk can be in a range of about 0.001 to about 0.2, or in some examples about 0.005 to about 0.175, or in some examples about 0.050 to about 0.125.

The composite textile can include an average Ssk based on a plurality of different areas of the surface, such as the first area 904, the second area 906, and the third area 908. In at least some examples, the average Ssk is positive. For example, the Ssk can be in a range of about 0.001 to about 0.2, or in some examples about 0.005 to about 0.175, or in some examples about 0.050 to about 0.125, or in some examples, about 0.085.

In some examples texture aspect ratio (Str) can indicate whether wrinkles are more aligned or directional, where lower values can indicate more aligned and higher values can indicate more randomness. Str can indicate the isotropy of the surface texture, derived from the autocorrelation function. For example, the autocorrelation function can measure how similar the surface is to itself when shifted in various directions. Str can quantify the ratio of the shortest to the longest autocorrelation length at which the autocorrelation function drops below a certain threshold (e.g., 0.2). Often, an Str closer to 1.0 can indicate that the surface is isotropic or that it has no preferred direction (e.g., wrinkles or texture are evenly distributed). An Str closer to 0.0 can indicate surface is anisotropic, meaning it has a strong directional pattern (e.g., grooves, folds, or aligned wrinkles).

In at least some examples, a composite textile of this disclosure (e.g., the composite textile 112 and/or 212) can include, along the first face 118, an Str across a surface area (e.g., a 5 cm×5 cm area or any of the areas 904, 906, or 908) that is less than 0.50, and in some examples less than 0.40, and in some examples less than 0.30, and in some examples less than 0.20. For example, the Str can be in a range of about 0.05 to about 0.40, or in some examples about 0.10 to about 0.30, or in some examples about 0.15 to about 0.25.

The composite textile can include an average Str based on a plurality of different areas of the surface, such as the first area 904, the second area 906, and the third area 908. In at least some examples, the average Str is less than 0.50, and in some examples less than 0.40, and in some examples less than 0.30, and in some examples less than 0.20. In some examples, the average Str can be in a range of about 0.05 to about 0.40, or in some examples about 0.10 to about 0.30, or in some examples about 0.15 to about 0.25.

In some examples arithmetic mean peak curvature (Spc) can indicate the arithmetic mean of the principal curvature of all the peaks detected on the surface and can indicate how sharp or rounded the peaks are—a higher Spc value can indicate sharper, more pointed peaks and a lower Spc value can indicate rounder, smoother peaks.

In at least some examples, a composite textile of this disclosure (e.g., the composite textile 112 and/or 212) can include, along the first face 118, an Spc across a surface area (e.g., a 5 cm×5 cm area or any of the areas 904, 906, or 908) that is in a range of about 5.525/mm to about 5.625/mm, or in some examples about 5.550/mm to about 5.600/mm, or in some examples about 5.575/mm to about 5.585/mm.

The composite textile can include an average Spc based on a plurality of different areas of the surface, such as the first area 904, the second area 906, and the third area 908. In at least some examples, the average Spc is in a range of about 5.525/mm to about 5.625/mm, or in some examples about 5.550/mm to about 5.600/mm, or in some examples about 5.575/mm to about 5.585/mm.

### Example Composite Textile

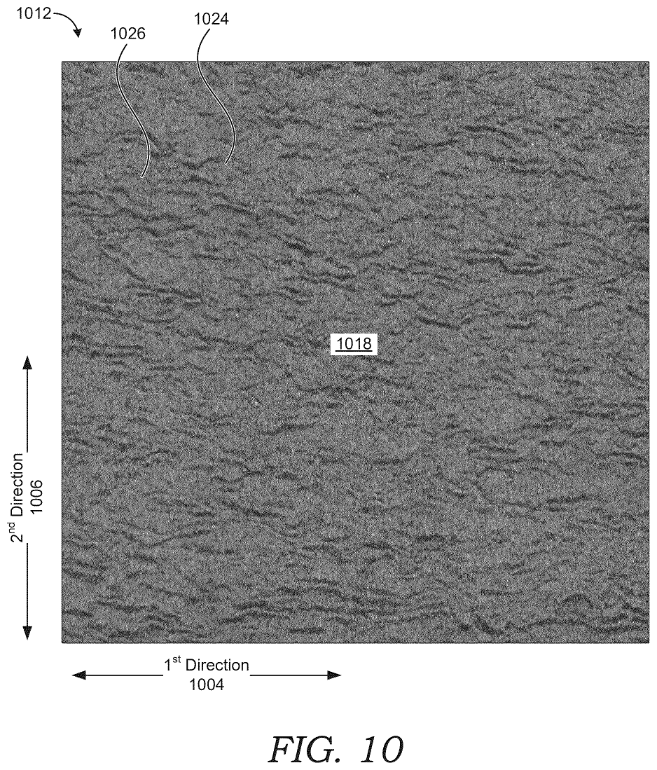

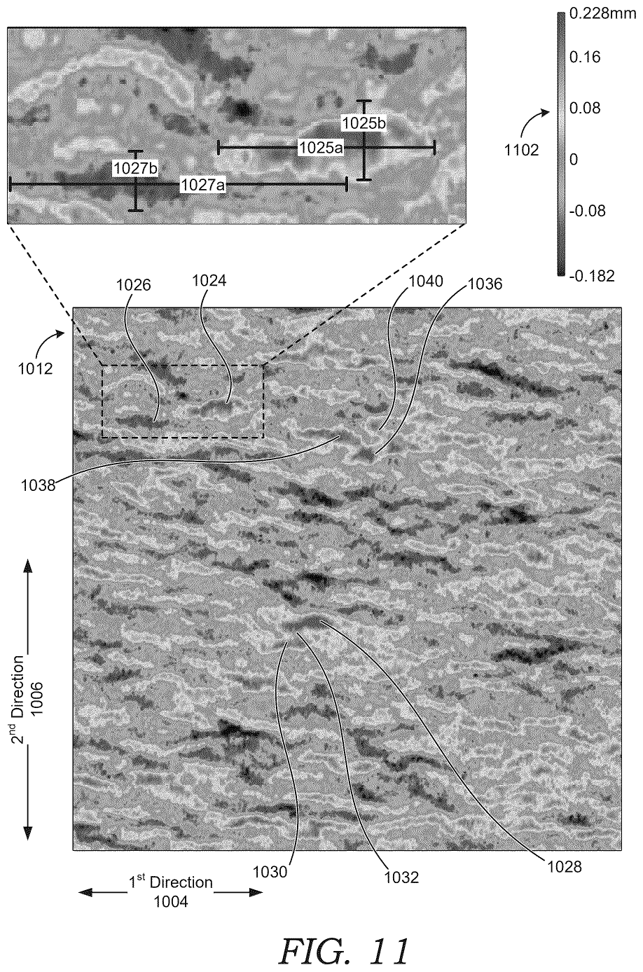

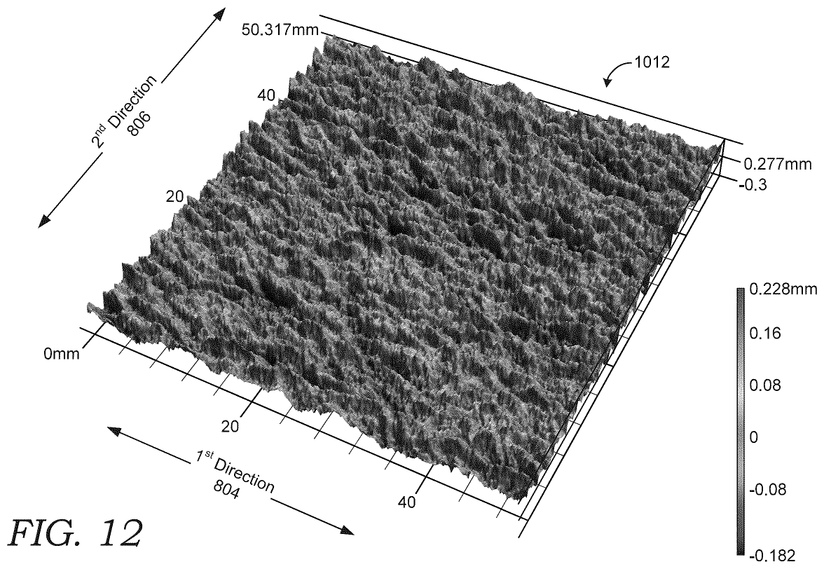

FIGS. 10 through 12 each depicts a digital rendering of a composite textile 1012 of the present disclosure (e.g., a sample of a composite textile cut into a square that is about 5 cm×5 cm), the digital rendering being created using a surface-analytical tool with imaging software (e.g., 3D Surface Profiler sold by Keyence®). In each of FIGS. 10, 11, and 12, a first face 1018 is shown, which corresponds with the face 118, and the first face 1018 can include an outer face of the composite textile 1012. In some examples, the first face 1018 can include an outer face of an apparel article, and in some cases, can include an outermost face of the apparel article. The composite textile 1012 includes a cross direction 1004 and a machine direction 1006. Each of the renderings in FIGS. 10, 11, and 12 illustrate the surface topographical properties of the composite textile 1012 in different manners. For example, FIG. 10 includes a black and white optical 3D model rendering; FIG. 11 includes a color-coded plan rendering in which each color represents a respective z-height based on a scale 1102; and FIG. 12 includes a color-coded perspective rendering showing z-height dimensionality, also using a similar color-coding scale 1202.

The composite textile 1012 includes a nonwoven layer (e.g., 114), which can form the first face 1018. In this example of the composite textile 1012, the nonwoven layer can include a spunlace having an average basis weight of about 40 gsm and PET fibers. Examples can include a nonwoven layer having any of the basis weights disclosed in this description. In addition, the composite textile 1012 includes a membrane (e.g., 116), which in this example includes a PU film that is coupled to the nonwoven layer by dot lamination or other application of discontinuous adhesive material deposits. In addition, the nonwoven layer includes DWR, which can be applied by dipping, and a chemical binder, which can be applied by gravure. The fibers of the nonwoven layer can also include a dye, which can be applied via CO2 sublimation or any other suitable method. The membrane can include a top coat, such as for improving hydrostatic pressure, and can also include discontinuous material deposits (e.g., on an inner-facing surface). The top coat and the discontinuous material deposits can be applied by gravure (e.g., in separate steps) or by any other suitable application process. In examples, the composite textile 1012 can have undergone at least three wash/dry cycles.

In examples, the first face 1018 can include wrinkles that are formed by clusters of fiber portions, which are displaced outward and away from the membrane. Stated another way, the wrinkles can include some fiber portions 1024 that are offset outward relative to other fiber portions 1026 in the z-direction (e.g., where first fiber portions 1024 pucker outward and form a ridge or a peak and second fiber portions 1026 are offset more inward and positioned closer to the membrane and form a valley). FIG. 10 illustrates an optical 3D rendering of the fiber portions 1024 and 1026, and FIG. 11 illustrates the color-coded relative z-direction positions of the fiber portions 1024 and 1026, where the red color coding in FIG. 11 indicates a larger z-direction position and the blue color code in FIG. 11 indicates a shallower z-direction position.

In at least some examples, wrinkles that are on the face 1018 can include a longitudinal orientation, and in some instances, the longitudinal orientation of a set of wrinkles (e.g., in a unit area or larger area) can extend in a similar direction. Stated differently, the set of wrinkles can be described as having a general directional pattern. For example, a ridge portion can include a longitudinal orientation that is aligned with a length of the ridge (e.g., the longer dimension 1025a in FIG. 11) and a lateral orientation that is aligned with a width of the ridge (e.g., the shorter dimension 1025b in FIG. 11). In addition, a valley portion can similarly include a longitudinal orientation (e.g., 1027a in FIG. 11) and a lateral orientation (e.g., 1027b in FIG. 11), which in many instances aligns with the longitudinal orientation and lateral orientation of the ridge portion. In at least some examples, the ridges of a set of wrinkles can longitudinally extend in a similar direction.

In at least some examples the similar direction in which the ridges extend is relative to a direction associated with the composite textile. For example, in some examples, the ridges can longitudinally extend in a direction that is more aligned with a cross direction 1004 of the composite textile 1012, as compared to a machine direction 1006 of the composite textile 1014. In some examples, the CD and the MD of the composite textile can also correspond with the CD and MD of the membrane (e.g., of the film) and/or the CD and the MD of the nonwoven layer.

In at least some examples, the texture and topography of the face 1018 can provide a desired surface ornamentation that is suitable and desired for wearable articles. For example, the composite textile 1012 of the present invention includes (in contrast to conventional composite textiles with nonwoven layers) the wrinkles with a higher degree of dimensional offset, which can provide an interesting and unique aesthetic. In some examples, the wrinkles can include a leather-like appearance. The wrinkles can also impart a hand feel that is desirable or preferred for some apparel articles. In some examples, the wrinkles can contribute to a drape property that is enhanced or different as compared to a composite textile that does not include the wrinkles.

The wrinkles can have various other structures. In at least some examples, the surface topography can include a first ridge 1028 (e.g., FIG. 11) and a second ridge 1030 that have longitudinal orientations more oriented in the direction 1004. In addition, the first ridge 1028 and the second ridge 1030 can be joined by a third ridge 1032 extending between the first ridge 1028 and the second ridge 1030. This bridge ridge construction with connected peaks can, in some instances, arise from a discontinuous lamination layer (e.g., dot-glue lamination) between the nonwoven layer and the membrane. For example, the omission of adhesive in some areas can allow a portion of the nonwoven layer associated with the third ridge 1032 to pucker outward.

In some examples, a ridge can include a first ridge portion that longitudinally extends in a direction that is more aligned with a cross direction 1004 and can also include one or more second ridge portions that branch off of the first portion. For example, a ridge can includes a first ridge portion 1036 (e.g., FIG. 11) that longitudinally extends in a direction that is more aligned with a cross direction 1004, and the ridge also includes additional ridge portions 1038 and 1040 that branch off of the first ridge portion 1036. This branched ridge construction can, in some instances, arise from a discontinuous lamination layer (e.g., dot-glue lamination) between the nonwoven layer and the membrane.

The topography of the face 1018 can have various topographical properties, which can be measured using one or more surface-analysis tools.

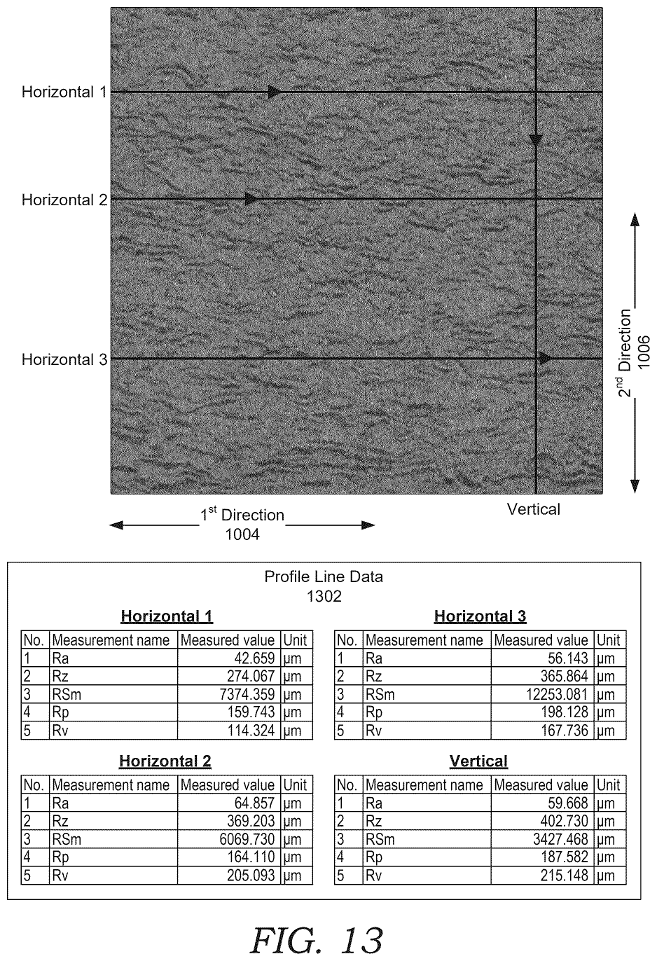

Referring to FIG. 13, the rendering from FIG. 10 is provided with markings showing profile lines associated with profile-line data 1302, including the arithmetical mean height or roughness (Ra), average maximum profile height between peaks and valleys (Rz), mean spacing of profile irregularities from one wrinkle to an adjacent wrinkle (RSm), maximum profile peak height (Rp), and maximum profile valley depth (Rv). In FIG. 13, the horizontal lines 1, 2, and 3 extend in the CD and the vertical line extends in the MD. As described with respect to FIG. 8, the profile-line data 1302 can provide insight into both the qualities and nature of the surface, as well as the orientation of the ridges and valleys. In at least some examples, one or more surface-topography properties can be controlled to control a size of the varied surface topography. For example, configuring an average Rz less than 500 μm can contribute to shallower recesses (e.g., valleys) on the surface, which can reduce the likelihood of debris (e.g., dirt, dust, VOCs, stains, etc.) being captured by the composite textile.

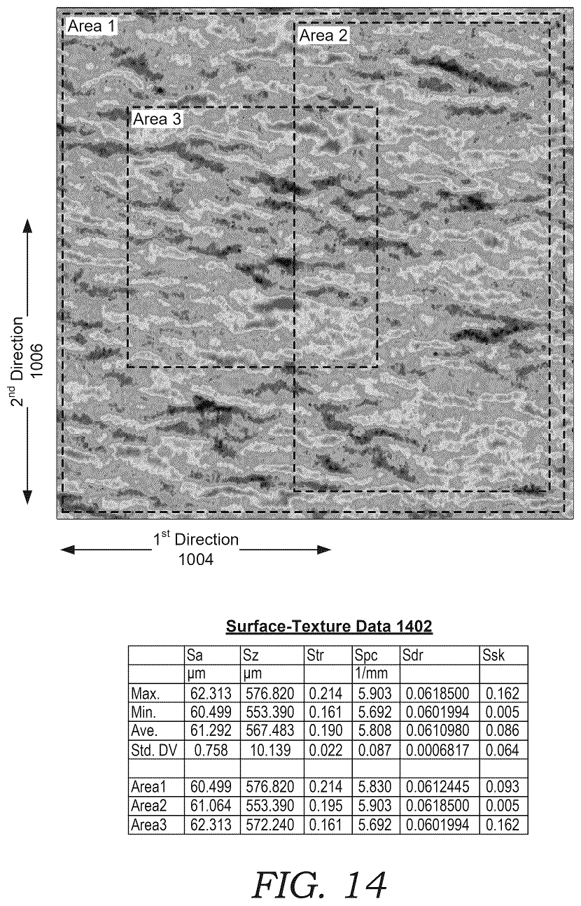

In an example, FIG. 14 includes the rendering from FIG. 11 with annotations and markings showing areas associated with surface-texture data 1402, including the Arithmetical Mean Height (Sa), Maximum Height (Sz), surface area ratio (Sdr), skewness (Ssk), texture aspect ratio (Str), and arithmetic mean peak curvature (Spc). As described with respect to FIG. 9, the profile-line data 1402 can provide insight into both the qualities and nature of the surface, as well as the orientation of the ridges and valleys. In at least some examples, one or more surface-topography properties can be controlled to control a size of the varied surface topography. For example, configuring properties to include shallower recesses (e.g., valleys) on the surface can, in some instances, reduce the likelihood of debris (e.g., dirt, dust, VOCs, stains, etc.) being captured by the composite textile.

### Example Clauses

The following clauses includes some examples of the present disclosure. Any of the clauses can include subject matter that can be included in any one or more claims.
Clause 1. An apparel article comprising: a composite textile comprising a nonwoven layer and a waterproof, breathable membrane; and the nonwoven layer comprising a first face that comprises an outer face of the article of apparel and a second face coupled to the waterproof, breathable membrane, wherein the first face comprises wrinkles that comprise first fiber portions that are displaced, relative to second fiber portions, further outward and away from the waterproof, breathable membrane.
Clause 2. The apparel article of clause 1, wherein the nonwoven layer comprises a staple fiber web, a spunlace layer, a meltblown layer, or any combination thereof.
Clause 3. The apparel article of clause 1, wherein the nonwoven layer comprises a spunlace layer comprising a basis weight in a range of about 30 gsm to about 80 gsm.
Clause 4. The apparel article of any of clauses 1 to 3, wherein the nonwoven layer comprises fibers that comprise a DWR coating.
Clause 5. The apparel article of any of clauses 1 to 4, wherein the nonwoven layer comprises chemical bonding sites.
Clause 6. The apparel article of any of clauses 1 to 5, wherein the nonwoven layer comprises fibers that comprise a sublimatedly impregnated colorant.
Clause 7. The apparel article of any of clauses 1 to 6, wherein the waterproof, breathable membrane comprises a film, a second nonwoven layer, or any combination thereof.
Clause 8. The apparel article of any of clauses 1 to 6, wherein the waterproof, breathable membrane comprises a polyurethane film that comprises a basis weight in a range of about 18 gsm to about 26 gsm.
Clause 9. The apparel article of any of clauses 1 to 8, wherein the composite textile comprises an adhesive layer between the nonwoven layer and the waterproof, breathable membrane; and wherein the adhesive layer bonds the second face to the waterproof, breathable membrane.
Clause 10. The apparel article of clause 9, wherein the adhesive layer comprises a plurality of discontinuous adhesive deposits.
Clause 11. The apparel article any of clauses 1 to 10, wherein the waterproof, breathable membrane comprises a third face that comprises an inner face of the apparel article.
Clause 12. The apparel article of clause 11, wherein the third face comprises a first polyurethane coating.
Clause 13. The apparel article of clause 11 or claim 12, wherein the third face comprises a second coating arranged in a pattern of discrete deposits.
Clause 14. The apparel article of any of clauses 1 to 13, wherein each wrinkle comprises a longitudinal orientation.
Clause 15. The apparel article of clause 14, wherein the composite textile comprises a cross direction and a machine direction; and wherein the longitudinal orientation of the wrinkles is more aligned with the cross direction.
Clause 16. The apparel article of any of clauses 1 through 15, wherein the waterproof, breathable membrane comprises, as compared to the nonwoven layer, a lower resistance to temperature-induced shrinkage.
Clause 17. An apparel article comprising: a composite textile comprising a nonwoven layer and a polyurethane film; the nonwoven layer comprising a first face that comprises an outer face of the article of apparel and a second face coupled to polyurethane film; and the polyurethane film comprising a third face coupled to the nonwoven layer and a fourth face that is opposite the third face, wherein the fourth face comprises a first coating that covers a first surface area of the fourth face; and wherein a second coating of discontinuous deposits is on the first coating and covers a second surface area that is less than the first surface area.
Clause 18. The apparel article of clause 17, wherein the nonwoven layer comprises a staple fiber web, a spunlace layer, a meltblown layer, or any combination thereof.
Clause 19. The apparel article of clause 17, wherein the nonwoven layer comprises a spunlace layer that comprises a basis weight in a range of about 30 gsm to about 80 gsm.
Clause 20. The apparel article of any of clauses 17 to 19, wherein the nonwoven layer comprises fibers that comprise a DWR coating.
Clause 21. The apparel article of any of clauses 17 to 20, wherein the nonwoven layer comprises chemical bonding sites that adhere to fiber ends and impede the fiber ends from migrating beyond the first face and forming pills.
Clause 22. The apparel article of any of clauses 17 to 21, wherein the nonwoven layer comprises fibers that comprise a sublimatedly impregnated colorant.
Clause 23. The apparel article of any of clauses 17 to 22, wherein the polyurethane film comprises micro-perforations.
Clause 24. The apparel article of any of clauses 17 to 23, wherein the polyurethane film comprises a basis weight in a range of about 18 gsm to about 26 gsm.
Clause 25. The apparel article of any of clauses 17 to 24, wherein the composite textile comprises an adhesive layer between the nonwoven layer and the polyurethane film; and wherein the adhesive layer bonds the second face to the third face.
Clause 26. The apparel article of clause 25, wherein the adhesive layer comprises a pattern of discontinuous adhesive deposits.
Clause 27. The apparel article any of clauses 17 to 26, wherein the first coating comprises a polyurethane-based coating configured to increase a hydrostatic pressure rating associated with the composite textile.
Clause 28. The apparel article of clause 27, wherein the second coating binds to a surface of the first coating.
Clause 29. The apparel article of clause 27 or claim 28, wherein the discontinuous deposits comprise a dot grid arrangement.
Clause 30. The apparel article of any of clauses 27 to 29, wherein the first face comprises wrinkles that comprise first fiber portions that are displaced, relative to second fiber portions, further outward and away from the polyurethane film.
Clause 31. The apparel article of clause 30, wherein each wrinkle comprises a longitudinal orientation.
Clause 32. The apparel article of clause 31, wherein the composite textile comprises a cross direction and a machine direction; and wherein the longitudinal orientation is more aligned with the cross direction.
Clause 33. The apparel article of any of clauses 17 through 32, wherein the polyurethane film comprises, as compared to the nonwoven layer, a lower resistance to temperature-induced shrinkage, and optionally wherein the polyurethane film shrinks more in a machine direction than in a cross direction.
Clause 34. An apparel article comprising: a composite textile comprising a nonwoven layer and a polyurethane film; and the nonwoven layer comprising a first face that comprises an outer face of the article of apparel and a second face coupled to the polyurethane film, wherein the polyurethane film comprises, as compared to the nonwoven layer, less resistance to temperature-induced shrinkage.
Clause 35. The apparel article of clause 34, wherein the first face comprises wrinkles that comprise first fiber portions that are displaced, relative to second fiber portions, further outward and away from the polyurethane film.
Clause 36. The apparel article of clause 34 or claim 35, wherein the nonwoven layer comprises a staple fiber web, a spunlace layer, a meltblown layer, or any combination thereof.
Clause 37. The apparel article of clause 34 or claim 35, wherein the nonwoven layer comprises a spunlace layer comprising a basis weight in a range of about 30 gsm to about 80 gsm.
Clause 38. The apparel article of any of clauses 34 to claim 37, wherein the nonwoven layer comprises fibers that comprise a DWR coating.
Clause 39. The apparel article of any of clauses 34 to 38, wherein the nonwoven layer comprises fiber ends that are bound in chemical bonding sites by a chemical binder.
Clause 40. The apparel article of any of clauses 34 to 39, wherein the nonwoven layer comprises fibers that comprise a sublimatedly impregnated colorant.
Clause 41. The apparel article of any of clauses 34 to 40, wherein, when exposed to temperature changes, the polyurethane film shrinks more in a machine direction than in a cross direction.
Clause 42. The apparel article of any of clauses 34 to 41, wherein the polyurethane film comprises a basis weight in a range of about 18 gsm to about 26 gsm.
Clause 43. The apparel article of any of clauses 34 to 42, wherein the composite textile comprises an adhesive layer between the nonwoven layer and the polyurethane film; and wherein the adhesive layer bonds the second face to the polyurethane film.
Clause 44. The apparel article of clause 43, wherein the adhesive layer comprises discontinuous adhesive-material deposits.
Clause 45. The apparel article any of clauses 34 to 44, wherein the polyurethane film comprises a third face that is oriented towards an inner side of the apparel article.
Clause 46. The apparel article of clause 45, wherein the third face comprises a first polyurethane coating.
Clause 47. The apparel article of clause 45 or claim 46, wherein the third face comprises a second coating that includes discontinuous discrete deposits.
Clause 48. The apparel article of clause 35, wherein each wrinkle comprises a longitudinal orientation.
Clause 49. The apparel article of clause 48, wherein the composite textile comprises a cross direction and a machine direction; and wherein the longitudinal orientation is more aligned with the cross direction.
Clause 50. An apparel article comprising: a composite textile comprising a nonwoven layer and a waterproof, breathable membrane; and the nonwoven layer comprising a first face that comprises an outer face of the article of apparel and a second face coupled to the waterproof, breathable membrane, wherein the first face comprises wrinkles associated with one or more surface-texture properties of the first face, and wherein the one or more surface-texture properties comprise an arithmetical mean height (Ra) in a range of about 40 μm to about 75 μm.
Clause 51. The apparel article of clause 50, wherein the one or more surface-texture properties of the first face comprise a first Ra measured along a first profile, a second Ra measured along a second profile perpendicular to the first profile, wherein the first Ra is smaller than the second Ra.
Clause 52. The apparel article of clause 51, wherein the first profile is more aligned with a cross direction (CD) of the composite textile than a machine direction (MD) of the composite textile, and wherein the second profile is more aligned with the MD of the composite textile than the CD of the composite textile.
Clause 53. The apparel article of any of clauses 50 to 52, wherein the nonwoven layer comprises a spunlace nonwoven textile.
Clause 54. The apparel article of clause 53, wherein the spunlace nonwoven textile comprises a basis weight in a range of about 30 gsm to about 80 gsm.
Clause 55. The apparel article of any of clauses 50 to 54, wherein the nonwoven layer comprises fibers comprising polyester.
Clause 56. The apparel article of any of clauses 50 to 55, wherein the waterproof, breathable membrane comprises a film, a second nonwoven layer, or any combination thereof.
Clause 57. The apparel article of clause 56, wherein the waterproof, breathable membrane comprises a film comprising polyurethane.
Clause 58. The apparel article of any of clauses 50 to 57, wherein the waterproof, breathable membrane comprises, as compared to the nonwoven layer, a lower resistance to temperature-induced shrinkage.
Clause 59. The apparel article of any of clauses 50 to 58, wherein, in response to exposure to heat, the waterproof, breathable membrane shrinks more in a machine direction than in a cross direction.
Clause 60. An apparel article comprising: a composite textile comprising a nonwoven layer and a waterproof, breathable membrane; and the nonwoven layer comprising a first face that comprises an outer face of the article of apparel and a second face coupled to the waterproof, breathable membrane, wherein the first face comprises wrinkles associated with one or more surface-texture properties of the first face, and wherein the one or more surface-texture properties comprise an average maximum profile height between peaks and valleys (Rz) that is greater than 250 μm and less than 500 μm.
Clause 61. The apparel article of clause 60, wherein the one or more surface-texture properties of the first face comprise a first Rz measured along a first profile, a second Rz measured along a second profile perpendicular to the first profile, wherein the first Rz is smaller than the second Rz.
Clause 62. The apparel article of clause 61, wherein the first profile is more aligned with a cross direction (CD) of the composite textile than a machine direction (MD) of the composite textile, and wherein the second profile is more aligned with the MD of the composite textile than the CD of the composite textile.
Clause 63. The apparel article of any of clauses 60 to 62, wherein the nonwoven layer comprises a spunlace nonwoven textile.
Clause 64. The apparel article of clause 63, wherein the spunlace nonwoven textile comprises a basis weight in a range of about 30 gsm to about 80 gsm.
Clause 65. The apparel article of any of clauses 60 to 64, wherein the nonwoven layer comprises fibers comprising polyester.
Clause 66. The apparel article of any of clauses 60 to 65, wherein the waterproof, breathable membrane comprises a film, a second nonwoven layer, or any combination thereof.
Clause 67. The apparel article of clause 66, wherein the waterproof, breathable membrane comprises a film comprising polyurethane.
Clause 68. The apparel article of any of clauses 60 to 67, wherein the waterproof, breathable membrane comprises, as compared to the nonwoven layer, a lower resistance to temperature-induced shrinkage.
Clause 69. The apparel article of any of clauses 60 to 68, wherein, in response to exposure to heat, the waterproof, breathable membrane shrinks more in a machine direction than in a cross direction.
Clause 70. An apparel article comprising: a composite textile comprising a nonwoven layer and a waterproof, breathable membrane; and the nonwoven layer comprising a first face that comprises an outer face of the article of apparel and a second face coupled to the waterproof, breathable membrane, wherein the first face comprises wrinkles associated with one or more surface-texture properties of the first face, and wherein the one or more surface-texture properties comprise mean spacing of profile irregularities (RSm) in a range of about 3,000 μm to about 14,000 μm.
Clause 71. The apparel article of clause 70, wherein the one or more surface-texture properties of the first face comprise a first Rsm measured along a first profile, a second Rsm measured along a second profile perpendicular to the first profile, wherein the first Rsm is larger than the second Rsm.
Clause 72. The apparel article of clause 71, wherein the first profile is more aligned with a cross direction (CD) of the composite textile than a machine direction (MD) of the composite textile, and wherein the second profile is more aligned with the MD of the composite textile than the CD of the composite textile.
Clause 73. The apparel article of any of clauses 70 to 72, wherein the nonwoven layer comprises a spunlace nonwoven textile.
Clause 74. The apparel article of clause 73, wherein the spunlace nonwoven textile comprises a basis weight in a range of about 30 gsm to about 80 gsm.
Clause 75. The apparel article of any of clauses 70 to 74, wherein the nonwoven layer comprises fibers comprising polyester.
Clause 76. The apparel article of any of clauses 70 to 75, wherein the waterproof, breathable membrane comprises a film, a second nonwoven layer, or any combination thereof.
Clause 77. The apparel article of clause 76, wherein the waterproof, breathable membrane comprises a film comprising polyurethane.
Clause 78. The apparel article of any of clauses 70 to 77, wherein the waterproof, breathable membrane comprises, as compared to the nonwoven layer, a lower resistance to temperature-induced shrinkage.
Clause 79. The apparel article of any of clauses 70 to 78, wherein, in response to exposure to heat, the waterproof, breathable membrane shrinks more in a machine direction than in a cross direction.
Clause 80. An apparel article comprising: a composite textile comprising a nonwoven layer and a waterproof, breathable membrane; and the nonwoven layer comprising a first face that comprises an outer face of the article of apparel and a second face coupled to the waterproof, breathable membrane, wherein the first face comprises wrinkles associated with one or more surface-texture properties of the first face, and wherein the one or more surface-texture properties comprise an arithmetical mean height (Sa) comprising an average height of the wrinkles relative to a mean height of the first face in a range of about 55 μm to about 65 μm.
Clause 81. The apparel article of clause 80, wherein the nonwoven layer comprises a spunlace nonwoven textile.
Clause 82. The apparel article of clause 81, wherein the spunlace nonwoven textile comprises a basis weight in a range of about 30 gsm to about 80 gsm.
Clause 83. The apparel article of any of clauses 80 to 82, wherein the nonwoven layer comprises fibers comprising polyester.
Clause 84. The apparel article of any of clauses 80 to 83, wherein the waterproof, breathable membrane comprises a film, a second nonwoven layer, or any combination thereof.
Clause 85. The apparel article of clause 84, wherein the waterproof, breathable membrane comprises a film comprising polyurethane.
Clause 86. The apparel article of any of clauses 80 to 85, wherein the waterproof, breathable membrane comprises, as compared to the nonwoven layer, a lower resistance to temperature-induced shrinkage.
Clause 87. The apparel article of any of clauses 80 to 86, wherein, in response to exposure to heat, the waterproof, breathable membrane shrinks more in a machine direction than in a cross direction.
Clause 88. An apparel article comprising: a composite textile comprising a nonwoven layer and a waterproof, breathable membrane; and the nonwoven layer comprising a first face that comprises an outer face of the article of apparel and a second face coupled to the waterproof, breathable membrane, wherein the first face comprises wrinkles associated with one or more surface-texture properties of the first face, and wherein the one or more surface-texture properties comprise texture aspect ratio (Str) less than 0.5.

Clause 89. The apparel article of clause 88, wherein the Str is less than about 0.40.
Clause 90. The apparel article of clause 88, wherein the Str is less than about 0.30.
Clause 91. The apparel article of clause 88, wherein the Str is less than about 0.20.
Clause 92. The apparel article of any of clauses 88 to 91, wherein the nonwoven layer comprises a spunlace nonwoven textile.
Clause 93. The apparel article of clause 92, wherein the spunlace nonwoven textile comprises a basis weight in a range of about 30 gsm to about 80 gsm.
Clause 94. The apparel article of any of clauses 88 to 93, wherein the nonwoven layer comprises fibers comprising polyester.
Clause 95. The apparel article of any of clauses 88 to 94, wherein the waterproof, breathable membrane comprises a film, a second nonwoven layer, or any combination thereof.
Clause 96. The apparel article of clause 95, wherein the waterproof, breathable membrane comprises a film comprising polyurethane.
Clause 97. The apparel article of any of clauses 88 to 96, wherein the waterproof, breathable membrane comprises, as compared to the nonwoven layer, a lower resistance to temperature-induced shrinkage.
Clause 98. The apparel article of any of clauses 88 to 97, wherein, in response to exposure to heat, the waterproof, breathable membrane shrinks more in a machine direction than in a cross direction.
Clause 99. An apparel article comprising: an asymmetric-faced composite textile comprising an outer face and an inner face, wherein the asymmetric-faced composite textile comprises a nonwoven layer and a waterproof, breathable membrane; and wherein the nonwoven layer is positioned, as compared to the waterproof, breathable membrane, closer to the outer face; the outer face comprising wrinkles that comprise first fiber portions that are displaced, relative to second fiber portions, further outward and away from the waterproof, breathable membrane; and the inner face comprising a first color property and comprising discontinuous material deposits comprising a second color property, which is different from the first color property.
Clause 100. The apparel article of clause 99, wherein a wrinkle from among the wrinkles comprises a longitudinal orientation; wherein the asymmetric-faced composite textile comprises a cross direction and a machine direction; and wherein the longitudinal orientation is more aligned with the cross direction than with the machine direction.
Clause 101. The apparel article of clause 99 or 100, wherein the waterproof, breathable membrane comprises a film comprising micro perforations; and wherein the waterproof, breathable membrane comprises a first face that faces towards the nonwoven layer and a second face that faces towards the inner face.
Clause 102. The apparel article of clause 101, wherein the second face comprises a polyurethane-based coating, and wherein the discontinuous material deposits are positioned on the polyurethane-based coating.
Clause 103. The apparel article of clause 102, wherein the polyurethane-based coating comprises the first color property.
Clause 104. The apparel article of any of clauses 101 to 103, wherein the second face comprises the first color property.
Clause 105. The apparel article of any of clauses 99 to 104, wherein the wrinkles comprise one or more surface-texture properties, and wherein the one or more surface-texture properties comprise an arithmetical mean height (Ra) in a range of about 40 μm to about 75 μm.
Clause 106. The apparel article of any of clauses 99 to 104, wherein the wrinkles comprise one or more surface-texture properties; wherein the one or more surface-texture properties comprise a first Ra measured along a first profile and a second Ra measured along a second profile perpendicular to the first profile; and wherein the first Ra is smaller than the second Ra.
Clause 107. The apparel article of clause 106, wherein the first profile is more aligned with a cross direction (CD) of the asymmetric-faced composite textile than a machine direction (MD) of the asymmetric-faced composite textile, and wherein the second profile is more aligned with the MD of the asymmetric-faced composite textile than the CD of the asymmetric-faced composite textile.
Clause 108. The apparel article of any of clauses 99 to 107, wherein the wrinkles comprise one or more surface-texture properties, and wherein the one or more surface-texture properties comprise an average maximum profile height between peaks and valleys (Rz) that is greater than 250 μm and less than 500 μm.
Clause 109. The apparel article of any of clauses 99 to 108, wherein the wrinkles comprise one or more surface-texture properties; wherein the one or more surface-texture properties comprise a first Rz measured along a first profile and a second Rz measured along a second profile perpendicular to the first profile; and wherein the first Rz is smaller than the second Rz.
Clause 110. The apparel article of clause 109, wherein the first profile is more aligned with a cross direction (CD) of the asymmetric-faced composite textile than a machine direction (MD) of the asymmetric-faced composite textile, and wherein the second profile is more aligned with the MD of the asymmetric-faced composite textile than the CD of the asymmetric-faced composite textile.
Clause 111. The apparel article of any of clauses 99 to 110, wherein the wrinkles comprise one or more surface-texture properties, and wherein the one or more surface-texture properties comprise mean spacing of profile irregularities (RSm) in a range of about 3,000 μm to about 14,000 μm.
Clause 112. The apparel article of any of clauses 99 to 111, wherein the wrinkles comprise one or more surface-texture properties comprising a first Rsm measured along a first profile and a second Rsm measured along a second profile perpendicular to the first profile; and wherein the first Rsm is larger than the second Rsm.
Clause 113. The apparel article of clause 112, wherein the first profile is more aligned with a cross direction (CD) of the asymmetric-faced composite textile than a machine direction (MD) of the asymmetric-faced composite textile, and wherein the second profile is more aligned with the MD of the asymmetric-faced composite textile than the CD of the asymmetric-faced composite textile.
Clause 114. The apparel article of any of clauses 99 to 113, wherein the wrinkles comprise one or more surface-texture properties, and wherein the one or more surface-texture properties comprise an arithmetical mean height (Sa) comprising an average height of the wrinkles relative to a mean height of the outer face in a range of about 55 μm to about 65 μm.
Clause 115. The apparel article of any of clauses 99 to 114, wherein the wrinkles comprise one or more surface-texture properties, and wherein the one or more surface-texture properties comprise texture aspect ratio (Str) less than 0.5.
Clause 116. The apparel article of any of clauses 99 to 115, wherein the asymmetric-faced composite textile includes any of the elements of the composite textile in any of clauses 1 to 98.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

This detailed description is provided in order to meet statutory requirements. However, this description is not intended to limit the scope of the invention described herein. Rather, the claimed subject matter may be embodied in different ways, to include different steps, different combinations of steps, different elements, and/or different combinations of elements, similar or equivalent to those described in this disclosure, and in conjunction with other present or future technologies. The examples herein are intended in all respects to be illustrative rather than restrictive. In this sense, alternative examples or implementations can become apparent to those of ordinary skill in the art to which the present subject matter pertains without departing from the scope hereof.

What is claimed is:

1. An apparel article comprising:
a composite textile comprising a nonwoven layer and a waterproof, breathable membrane; and
the nonwoven layer comprising a first face that comprises an outer face of the article of apparel and a second face coupled to the waterproof, breathable membrane, wherein the first face comprises wrinkles that comprise first fiber portions that are displaced, relative to second fiber portions, further outward and away from the waterproof, breathable membrane.

2. The apparel article of claim 1, wherein each wrinkle comprises a respective longitudinal orientation; wherein the composite textile comprises a cross direction and a machine direction; and wherein one or more of the respective longitudinal orientations is more aligned with the cross direction than the machine direction.

3. The apparel article of claim 1, wherein the wrinkles comprise one or more surface-texture properties, and wherein the one or more surface-texture properties comprise an arithmetical mean height (Ra) in a range of about 20 μm to about 200 μm.

4. The apparel article of claim 1, wherein the wrinkles comprise one or more surface-texture properties comprising a first mean spacing of profile irregularities (Rsm) measured along a first profile and a second Rsm measured along a second profile perpendicular to the first profile; and wherein the first Rsm is larger than the second Rsm.

5. The apparel article of claim 4, wherein the first profile is more aligned with a cross direction (CD) of the composite textile than a machine direction (MD) of the composite textile, and wherein the second profile is more aligned with the MD of the composite textile than the CD of the composite textile.

6. The apparel article of claim 1, wherein the wrinkles comprise one or more surface-texture properties, and wherein the one or more surface-texture properties comprise texture aspect ratio (Str) less than 0.5.

7. The apparel article of claim 1, wherein the wrinkles comprise a first ridge and a second ridge that longitudinally extend in a first direction, and wherein the wrinkles comprise a third ridge that extends between the first ridge and the second ridge.

8. The apparel article of claim 7, wherein the first direction is aligned with a cross direction of the composite textile.

9. The apparel article of claim 1, wherein the wrinkles comprise a first ridge that longitudinally extends in a direction aligned with a cross direction of the composite textile, and wherein the first ridge comprises one or more second ridges that branch off of the first ridge.

10. The apparel article of claim 1, wherein the waterproof, breathable membrane comprises a third face that comprises an inner face of the apparel article.

11. The apparel article of claim 10, wherein the third face comprises a first polyurethane coating.

12. The apparel article of claim 11, wherein the third face comprises a second coating arranged in a pattern of discrete material deposits.

13. The apparel article of claim 1, wherein the apparel article comprises an upper-body garment.

14. An apparel article comprising:
an asymmetric-faced composite textile comprising an outer face and an inner face, wherein the asymmetric-faced composite textile comprises a nonwoven layer and a waterproof, breathable membrane; and wherein the nonwoven layer is positioned, as compared to the waterproof, breathable membrane, closer to the outer face;
the outer face comprising wrinkles that comprise first fiber portions that are displaced, relative to second fiber portions, further outward and away from the waterproof, breathable membrane; and
the inner face comprising a first color property and comprising discontinuous material deposits comprising a second color property.

15. The apparel article of claim 14, wherein a wrinkle from among the wrinkles comprises a longitudinal orientation; wherein the asymmetric-faced composite textile comprises a cross direction and a machine direction; and wherein the longitudinal orientation is more aligned with the cross direction than with the machine direction.

16. The apparel article of claim 14, wherein the waterproof, breathable membrane comprises a film comprising a first face that faces towards the nonwoven layer and a second face that faces towards the inner face.

17. The apparel article of claim 16, wherein the second face comprises a polyurethane-based coating, and wherein the discontinuous material deposits are positioned on the polyurethane-based coating.

18. The apparel article of claim 17, wherein the polyurethane-based coating comprises the first color property.

19. The apparel article of claim 14, wherein the first color property is different from the second color property.

20. A composite textile comprising:
a nonwoven layer and a waterproof, breathable membrane; and
the nonwoven layer comprising a first face that comprises an outer face of the composite textile and a second face coupled to the waterproof, breathable membrane, wherein the first face comprises a wrinkle that comprises first fiber portions that are displaced, relative to second fiber portions, further outward and away from the waterproof, breathable membrane; wherein the wrinkle comprises a longitudinal orientation; and wherein the longitudinal orientation is more aligned with a cross direction of the composite textile than with a machine direction of the composite textile.

21. The composite textile of claim 20, wherein the first face comprises one or more surface-texture properties, and wherein the one or more surface-texture properties comprise an arithmetical mean height (Ra) in a range of about 20 μm to about 200 μm.

22. The composite textile of claim 21, wherein the first face comprises one or more surface-texture properties comprising a first Rsm measured along a first profile and a second Rsm measured along a second profile perpendicular to the first profile; and wherein the first Rsm is larger than the second Rsm.

23. The composite textile of claim 22, wherein the first profile is more aligned with the cross direction (CD) than with the machine direction (MD), and wherein the second profile is more aligned with the MD than with the CD.

24. The composite textile of claim 23, wherein the first face comprises one or more surface-texture properties, and wherein the one or more surface-texture properties comprise texture aspect ratio (Str) less than 0.5.
